(19) United States
(12) Patent Application Publication
(10) Pub. No.: US 2017/0016577 A1
(43) Pub. Date: Jan. 19, 2017

(54) Liquid Air Energy Storage Systems, Devices, and Methods

(71) Applicant: MADA ENERGIE LLC, New York, NY (US)

(72) Inventors: Stanislav SINATOV, Kiryat-Ono (IL); Leon AFREMOV, Tel Aviv (IL)

(73) Assignee: MADA ENERGIE LLC, New York, NY (US)

(21) Appl. No.: 15/124,507

(22) PCT Filed: Mar. 12, 2015
(86) PCT No.: PCT/US15/20306

§ 371 Date: Sep. 8, 2016

Related U.S. Application Data
(60) Provisional application No. 61/951,907, filed on Mar. 12, 2014.
(60) Provisional application No. 61/955,156, filed on Mar. 18, 2014.

(51) Int. Cl. F17C 9/04; F25J 1/02; F25J 1/00

(52) U.S. Cl. CPC F17C 9/04; F25J 1/0012; F25J 1/0042; F25J 1/0228; F25J 2205/24; F25J 2240/10; F25J 2240/90; F17C 2270/0581; F25J 2230/30

(57) ABSTRACT

Liquid air energy storage (LAES) systems with increased efficiency and operating profit obtained through rational selection and configuration of the equipment used and optimization of the configuration/parameters of such equipment. In various embodiments, the LAES system is intended for operation preferably in an environmentally-friendly stand-alone regime with recovery of hot thermal energy extracted from compressed charging air and cold thermal energy extracted from discharged air.

### CROSS-REFERENCE TO RELATED APPLICATIONS

The present application claims the benefit of U.S. Provisional Application No. 61/951,907, filed Mar. 12, 2014, and U.S. Provisional Application No. 61/955,156, filed Mar. 18, 2014, which are each hereby incorporated by reference herein in their entireties.

### FIELD

This present disclosure relates generally to energy storage and generation, and, more particularly, to liquid air energy storage (LAES) systems with significantly increased efficiency and operating profit obtained through rational selection and configuration of the equipment used and optimization of the configuration/parameters of such equipment. In various embodiments, the LAES system is intended for operation preferably in an environmentally-friendly stand-alone regime with recovery of hot thermal energy extracted from compressed charging air and cold thermal energy extracted from discharged air.

### BACKGROUND

A planned and started transfer to the decarbonized power grids is based first of all on increased use of renewable (mainly wind and solar) energy sources, a share of which in global electricity generation should be increased up to 11-12% by 2050 in the BLUE Map scenario; see “Prospects for Large-Scale Energy Storage in Decarbonized Power Grids”, Working Paper, IEA 2009. However with large shares of these technologies, it may be desirable to take steps to ensure the on-demand and reliable supply of electricity, taking into account a variable output of the renewable energy sources and a frequent both positive and negative unbalance between this output and a current demand for power. One of the possible ways for solving this problem is the use of large-scale energy storages in the decarbonized power grids. According to the mentioned IEA estimates, an installed capacity of such energy storages should be increased from 100 GW in 2009 up to 189-305 GW by 2050. The large-scale energy storages could also solve a problem of operating the base-load (mainly coal and nuclear) power plants without significant reduction in the output of their steam generators during off-peak (low demand for power) hours in electrical grids.

Amongst the energy storage technologies able to accumulate a lot of energy and store it over a long time-period, a recently proposed Liquid Air Energy Storage (LAES) technology is distinguished by the freedom from any geographical, land, and/or environmental constraints inherent in other large-scale energy storage technologies such as Pumped Hydroelectrical Storage and Compressed Air Energy Storage. In addition, LAES technology is characterized by much simpler permitting process and a possibility for co-location with any available sources of natural or artificial, cold or/and hot thermal energy, which may be used for enhancement of its power output; see “Liquid Air in the Energy and Transport Systems”, Centre for Low Carbon Futures, May 2013.

Some LAES system improvements studied by the inventors are related to the LAES systems using supercritical air pressure range and equipped with hot thermal energy storage. The heat storages provide some or all of the hot thermal energy required for discharged air heating and superheating through extraction of this energy from compressed charging air stream and its storing between the LAES charging and discharging. In particular, such a system is proposed in U.S. Publication No. 2012/0216520, Chen et al., (hereinafter “Chen”) in which storage and recovery of the hot thermal energy captured from charging air during its compression up to 38-340 barA is described in a possible integration with external waste heat or solar energy recovery. However, for the lowermost pressure values (e.g. 39-40 barA) in the indicated pressure range, Chen discloses using a compressor train comprising at least two compressors placed in series, which may be excessively complicated for the lowermost pressure values. By contrast, Chen discloses only a one-stage heat storage design for the different pressure and temperature of air. In addition, there are technologically justified limits for a maximum value of charging air pressure at the outlet of compressor train in large-scale LAES systems, which are usually far less than indicated in Chen. Finally, Chen's disclosed availability of external waste heat or solar energy sources co-located and integrated with the LAES system permits use of the simpler, cheaper and less energy-intensive intercooled compression of charging air with dissipation of compression heat into environmental surroundings.

Other LAES system improvements studied by the inventors are related to the LAES systems using supercritical air pressure range and equipped with cold thermal energy storage. The cold storages provide some or all of the cold thermal energy required for charging air liquefaction through extraction of this energy from the discharged air stream and its storing between the LAES discharging and charging. In particular, such a system is also described in Chen. Chen discloses a LAES operating in a wide range of the possible pressures of the charging air stream (P_{CH}) and the discharged air stream (P_{DCH}) from 38 to 340 barA and at any their possible relationship is described. However, investigations conducted with regard to the air thermodynamic properties at the cryogenic temperatures and supercritical pressures have revealed a possibility of such operation without any additional cold source only at a pressure P_{CH} somewhat exceeding a pressure P_{DCH}. In so doing, the higher the selected P_{CH} value is in relation to the P_{DCH} value, the lower the resulting LAES round-trip efficiency.

Therefore, there may be need for an improved stand-alone LAES system, operated in a more narrow range of the possible supercritical pressures of charging air (P_{CH}) and equipped with a technologically and economically justified minimal number of the compressor train and compression heat storage stages. In addition, in such improved stand-alone LAES system non-supported by any external cold source, a selected pressure of discharged air (P_{DCH}) should be not only less that a P_{CH} value, but be maintained at a level providing a minimum possible pressure difference (P_{CH}-P_{DCH}), resulting in a reasonably high round-trip efficiency of the LAES system.

### SUMMARY

In one or more embodiments, a proposed LAES system may comprise in combination: a compressor unit consuming off-peak power and providing compression of charging air up to pressure above a critical pressure, a hot thermal energy storage unit adapted to capture, storing and recovery of compression heat for superheating and reheating a discharged air, regenerable adsorber unit providing physical adsorption of the CO₂ and atmospheric moisture from charging air, a cryogenic unit adapted to deep cooling and liquefaction of pressurized charging air and re-gasification of pumped discharged air, the liquid air expander and separation units providing depressurization and separation of the liquified charging air, a liquid air storage unit, a liquid air pump unit providing pumping a discharged liquid air at a selected pressure below one of charging air, and an expander unit providing expansion of the pressurized discharged air and producing on-peak power.

In one or more embodiments, the improvements in the system may further include in combination:

the compressor unit including a combination of at most two placed in-series adiabatic compression stages providing a pressure of the charging air at the outlet of compressor unit in the range from 39 to 80 barA with a compression ratio in the one-stage compressor unit set up at a level of at least 39 or a compression ratio in the first stage of compressor unit selected in the range from 11 to 39;

the expander unit including a combination of at most two placed in-series adiabatic expansion stages providing an expansion ratio in the first stage of expander unit between 9 and 43 and expansion of air in the expander unit from a selected discharged air pressure down to an exhaust pressure exceeding an atmospheric pressure by 0.05-0.2 bar at most;

the hot thermal energy storage unit including a combination of at most two hot thermal energy storages in which the first storage is adapted to capture and store a compression heat generated correspondingly by one-stage or the first stage compressor and to recover a stored compression heat by one-stage or the first stage expander correspondingly, whereas the second storage is adapted to capture and store a compression heat generated by the second stage compressor and to recover a stored compression heat by the second stage expander;

the liquid air pump unit pumping a discharge air from a liquid air storage unit at a selected pressure providing a relationship between the pressures of the charging air at the inlet of the cryogenic unit during LAES charge phase and of discharged air stream at the inlet of the cryogenic unit during LAES discharge phase in the range from 1.15 to 3.35;

the cryogenic unit providing a difference in temperature of the gaseous charging air stream at the inlet of the unit during LAES charge phase and of the re-gasified discharged air stream at the outlet of the unit during LAES discharge phase selected in the range from 1 to 13° C.; and

the cryogenic unit wherein a lesser value of the relationship between the pressure of the charging and discharged air streams corresponds to a lesser value of the difference in temperature of the gaseous charging and re-gasified discharged air streams at a rated air liquefaction ratio of 95-96% and a rated difference in 3-5° C. between the temperatures of liquid charging air at the outlet of the cryogenic unit and of liquid discharged air at the inlet of the cryogenic unit.

In some embodiments, the improvements in the system may further provide a design of the compressor unit as a one-stage adiabatic turbo-machinery, including the placed in-series one-stage adiabatic compressor and charging air aftercooler, and providing the temperatures of charging air at the outlet of the equipment in the ranges: 350-580° C. and 40-60° C., correspondingly. The improvements in the system may further provide a design of the compressor unit as a two-stage semi-adiabatic turbo-machinery, wherein the compressor unit is a two-stage semi-adiabatic turbo-machinery, including placed in-series the first stage with a low pressure adiabatic compressor and charging air intercooler, and the second stage with a high pressure adiabatic compressor and charging air aftercooler. Thereby the two-stage compressor unit provides the temperatures of charging air at the outlet of the equipment in the following ranges: 350-580° C. and 40-60° C. respectively for the first stage of compressor unit and 280-120° C. and 40-60° C. respectively for the second stage of compressor unit.

In some embodiments, the improvements in the system may further provide a design of the expander unit as a one-stage adiabatic turbo-machinery, including the placed in-series air superheater and an adiabatic expander. The improvements in the system may further provide a design of the expander unit as a two-stage semi-adiabatic turbo-machinery, including the placed in-series air superheater and high pressure adiabatic expander in the first stage, and air reheater and low pressure adiabatic expander in the second stage, and providing an expansion ratio in the high pressure expander selected in the following ranges: between 9.5 and 10.5 for a charging air temperature at outlet of the first stage compressor in the range from 300 to 400° C.; between 16.5 and 19 for a charging air temperature at outlet of the first stage compressor in the range from 400 to 500° C.; and between 27.5 and 42.5 for a charging air temperature at outlet of the first stage compressor in the range from 500 to 575° C.

In some embodiments, the improvements in the system may further include the charging air intercooler and aftercooler used for supplying the hot thermal energy storages with compression heat during LAES charge, and the discharged air superheater and reheater used for extraction of stored compression heat from the hot thermal storages and its recovery during LAES discharge.

The heat storing media for the hot thermal energy storages may be selected from the group including solid, liquid, phase-change materials and combination thereof and configured in such way to provide a direct or indirect exchange of thermal energy stored by this media with the charging and discharge air streams using the charging air intercooler and/or aftercooler and the discharged air reheater and/or superheater. Thereby the charging air intercooler and aftercooler may be integrated with the rear-mounted balance water-or-air-cooled heat exchangers, providing a further reduction in temperature of charging air at their outlet down to 30° C. at least and drainage of condensate from cooled air.

In some embodiments, the improvements in the system may further include the adsorber unit designed as one pressurized vessel with at least one bed of the known industrial adsorbent providing a temperature swing adsorption or pressure-assisted temperature swing adsorption of contaminants and thermally regenerated by the discharged air escaping the expander train. The improvements in the system may further include the adsorber unit providing a temperature swing adsorption of contaminants and placed between the first balance heat exchanger and the high pressure compressor. The improvements in the system may further include the adsorber unit providing a pressure-assisted temperature swing adsorption of contaminants and placed between the second balance heat exchanger and the cryogenic unit.

In some embodiments, the improvements in the system may further include the cryogenic unit designed as a combination of a cold thermal energy storage, partitioned into placed in-series first and second storages, providing 57-59% and 39-40% respectively of a total cold capacity of the cryogenic unit, and a vapor cold exchanger, arranged in parallel with the first storage and providing up to 3% of total cold capacity of cryogenic unit. For these purposes the cryogenic unit may be equipped with a controlled divider installed at the inlet of unit and intended for separating a mass flow of charging air between the first cold storage and vapor cold exchanger in the proportion (94-96)% to (6-4)% and with an uncontrolled mixer installed upstream of the second cold storage and intended for mixing the charging air streams escaping the first cold storage and vapor cold exchanger. The first cold storage and vapor cold exchanger may be adapted to deeply cool the passing charging air down to −120-−140° C., whereas the second cold storage may be adapted to liquefy and subcool the full charging air flow down to −186-−187° C. A cold storing media for the cold thermal energy storage may be selected from the group including solid, liquid, phase-change materials and combination thereof and providing a direct or indirect exchange of thermal energy stored by this media with the charging and discharged air streams.

In some embodiments, the improvements in the system may further include the liquid air expander unit providing a share of vapor phase in the charging air stream at its outlet in the range between 0 and 0.5% and the liquid air separator unit providing a rated air liquefaction ratio by setting the temperature and pressure of the vapor and liquid phases of a charging air stream at its outlet in the range from 1.29 and 1.35 barA and between −191.7 and −192.1° C. correspondingly.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements. As used herein, various embodiments can mean one, some, or all embodiments.

FIG. 1A illustrates a LAES system, according to one or more embodiments of the disclosed subject matter.

FIG. 1B illustrates a LAES system with two-stage semi-adiabatic compression of the charging air to enhance round-trip efficiency of the system, according to one or more embodiments of the disclosed subject matter.

FIG. 1C is a table illustrating various configurations of LAES systems with two-stage semi-adiabatic compression of the charging air, according to one or more embodiments of the disclosed subject matter.

FIG. 2A-2D are the graphs showing a discharged air stream pressure for given charging air pressures at a rated difference in the streams temperature at the cryogenic unit inlet which are preserved, according to one or more embodiments of the disclosed subject matter.

FIG. 3 is a graph showing the summary interrelationship between charging and discharged air pressures at the rated differences in their temperature at the cryogenic unit inlet, according to one or more embodiments of the disclosed subject matter.

FIG. 4 is a graph showing an impact of the selected discharged air pressure on the LAES round-trip efficiency, according to one or more embodiments of the disclosed subject matter.

FIG. 5 is a graph showing an impact of the selected air temperature at the low pressure compressor outlet and selected air pressure at the high pressure compressor outlet on the LAES round-trip efficiency at the maximum value of discharged air pressure, according to one or more embodiments of the disclosed subject matter.

FIG. 6 is a graph showing an impact of the selected air temperature at the low pressure compressor outlet and selected air pressure at the high pressure compressor outlet on the LAES round-trip efficiency at the minimum values of discharged air pressure, according to one or more embodiments of the disclosed subject matter.

FIG. 7 illustrates a LAES system with two-stage semi-adiabatic compression of the charging air and an adsorber installed between a second high temperature storage stage and a cryogenic unit, according to one or more embodiments of the disclosed subject matter.

### DETAILED DESCRIPTION

In accordance with the presently disclosed subject matter, a stand-alone liquid air energy storage (LAES) system charges a storage with liquid air and recoverable hot thermal energy through consumption of power from the grid or any other source during, for example, periods of low-priced excess electricity. At other time periods, such as when electricity has greater economic value, the LAES system allows the discharge of the storage through conversion of the stored liquid air and thermal energy into power delivered to the grid or to any other consuming application, as well as the charge of the storage with recoverable cold thermal energy.

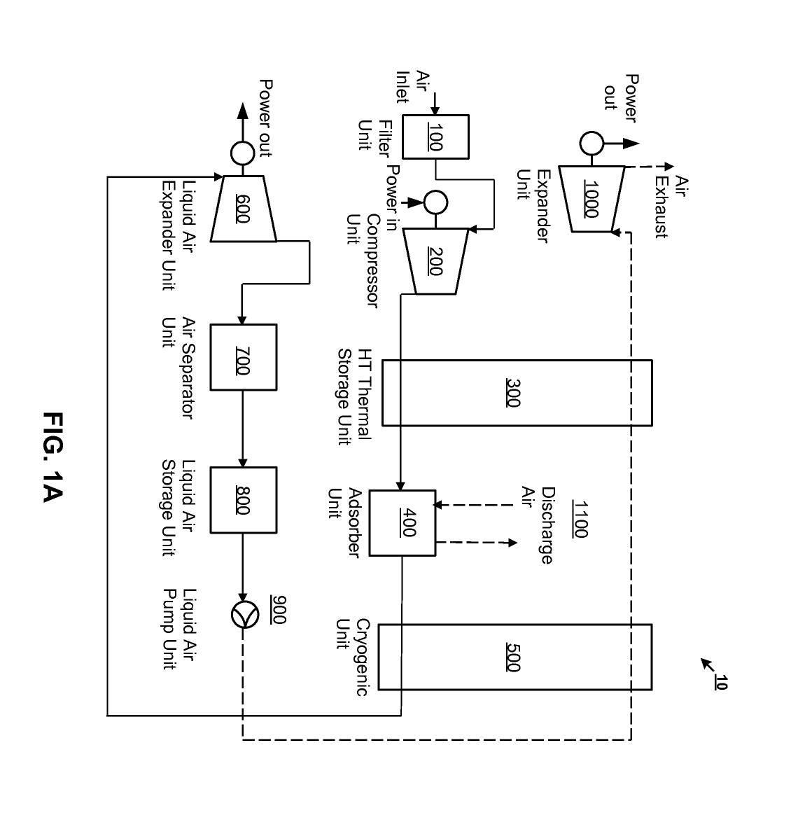

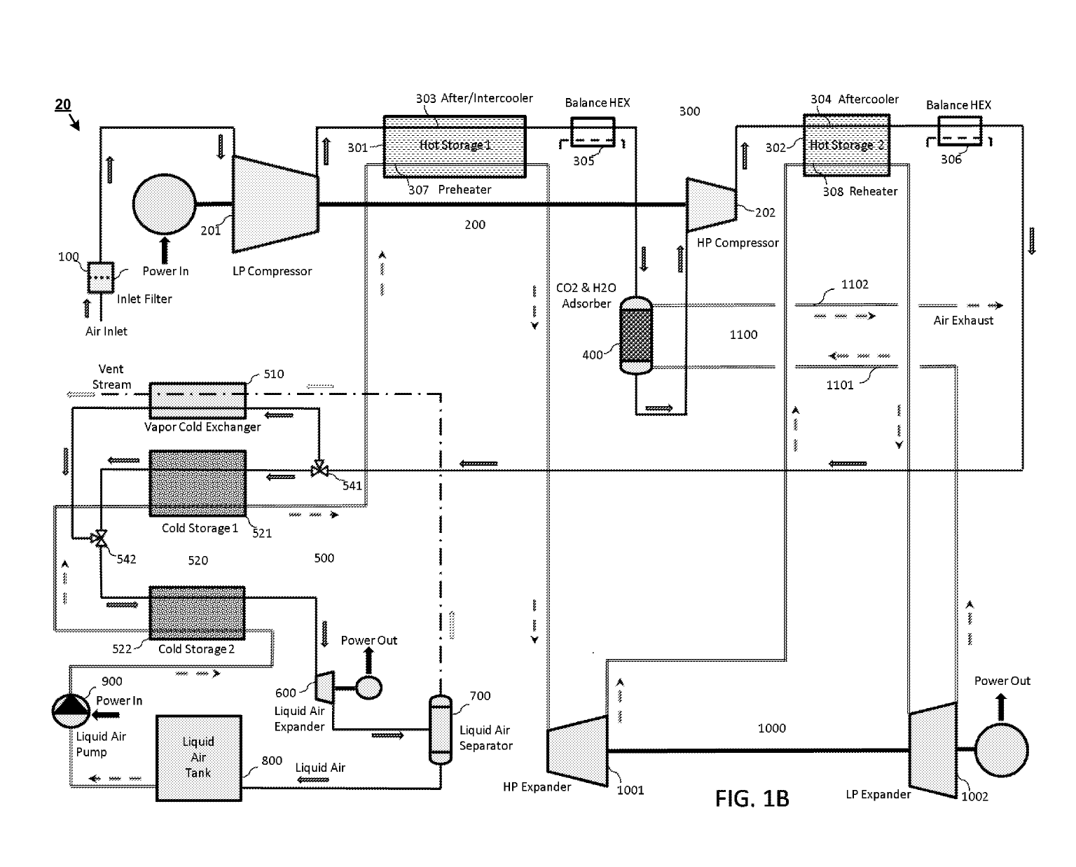

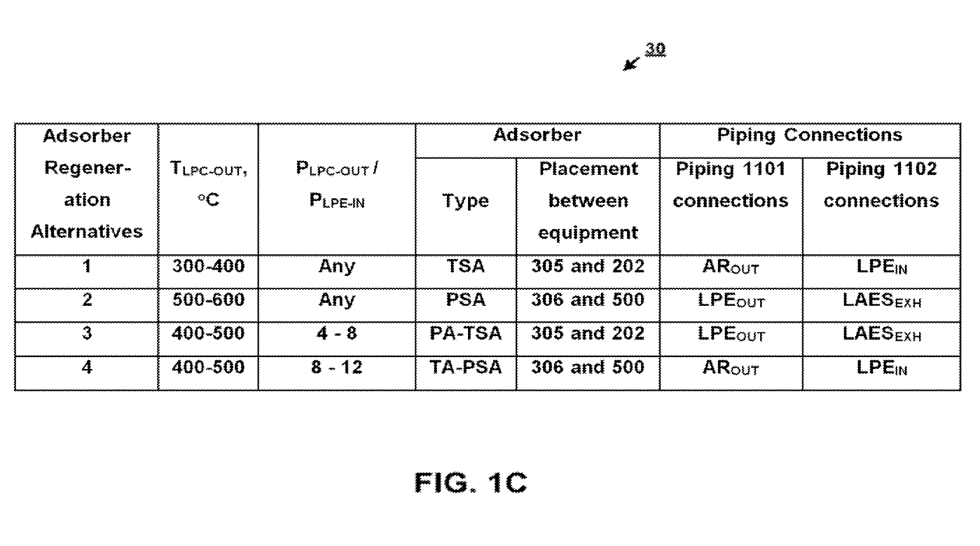

FIG. 1A illustrates a LAES system 10, according to one or more embodiments of the disclosed subject matter. LAES 10 comprises an inlet filter unit 100, a compressor unit 200, a hot thermal energy storage unit 300, an adsorber unit 400, a cryogenic unit 500, a liquid air expander unit 600, a flash liquid air separator unit 700, a liquid air storage unit 800, a liquid air pump unit 900, and an expander unit 1000.

LAES system 10 can be configured to operate in a charging mode to charge LAES 10 in which: inlet filter unit 100 captures air from the atmosphere and removes undesirable contaminants; inlet filter unit 100 capturing air from the atmosphere and removing undesirable contaminants; compressor unit 200 compressing a charging air stream (indicated by solid lines) to a supercritical charging pressure and consuming for this purpose a power from a predefined source, such as the grid; hot thermal energy storage unit 300 capturing and storing a heat of compression of the pressurized charging air stream and removing a major fraction of atmospheric moisture from a cooled air; adsorber unit 400 removing CO₂ contaminants and a remainder of the atmospheric moisture from the cooled and pressurized charging air stream and retaining the same in the adsorbent bed for removal by a discharged flow during discharging the system; cryogenic unit 500 further cooling and liquefying the pressurized charging air stream by capturing a cold thermal energy from a cold storing media and a cold vapor stream; liquid air expander unit 600 reducing a pressure of the charging air stream with a consequent additional air cooling and formation of a two-phase charging air stream at the outlet of the expander; flash liquid air separator unit 700 separating liquid and vapor fractions of the charging two-phase air stream, resulting in formation of liquid and gas outlet streams at the final pressure and temperature of the charging air with the liquid air stream being a main product of the charging process and the vapor vent air stream being a by-product of this process; and liquid air storage unit 800 storing the charging liquid air between the periods of the LAES charge and discharge.

LAES system 10 can also be configured to operate in a discharging mode in which: liquid air pump unit 900 capturing discharged liquid air from the liquid air tank 800 and conveying it to the cryogenic unit 500 at a selected discharged air pressure below than the charging air one; the cryogenic unit 500 heating and re-gasifying the pumped discharged air stream by releasing a cold thermal energy from this stream to a cold storing media; the hot thermal energy storage unit 300 further heating and reheating the discharged air stream by recovering a compression heat, stored therein; expander unit 1000 providing expansion of the heated discharged air stream and delivering the generated power to the grid or other consumer; and piping 1100 being used for delivery of the discharged air to the bed of adsorber unit 400 and for removal of this air together with CO₂ and atmospheric moisture from the adsorbent bed, thus providing an adsorber regeneration.

Various embodiments comprise LAES systems that include certain features that enable significant simplification and improvement of the system performance (i.e., the round-trip efficiency) and thereby enhance the operation profit. These features are described below by the example of the preferable embodiment of the proposed LAES system.

FIG. 1B illustrates a LAES system with two-stage semi-adiabatic compression of the charging air to enhance round-trip efficiency of the system, according to one or more embodiments of the disclosed subject matter. Compressor unit 200 represents a dynamic turbo-machinery, providing at most two-stage compression of the charging air up to a selected pressure above the supercritical value (37.7 barA) and not exceeding 75-80 barA. For the charging air pressure not exceeding 39-40 barA, the compressor unit 200 may be configured as a one-stage adiabatic turbo-machinery with one compressor, compressor 201, equipped with an air aftercooler, aftercooler 303. A two-stage alternative may include a semi-adiabatic turbo-machinery, combining the low and high pressure adiabatic compressors 201 and 202 placed in-series and equipped with an air intercooler 303 and an air aftercooler 304. The compressor 201 in a one-stage or a two-stage turbo-machinery, as well as the compressor 202 in two-stage turbo-machinery may be designed as multiple compressors placed in-parallel and providing a required summary capacity. This arrangement may be particularly suitable for systems exceeding 100-300 MW of power capacity.

In various embodiments, compressor 201 may be designed as an adiabatic turbo-machinery for operation at a maximum possible air temperature at its outlet, resulting in a significant increase in the LAES round-trip efficiency. For this purpose an uncooled industrial compressor, providing adiabatic compression with an outlet air temperature up to 350° C., or a slightly modified uncooled compressor, derived from design of the commercial gas turbines and admitting an outlet air temperature up to 550° C. and above may be used. To provide a desirable enhanced temperature at the outlet of compressor 201, its compression ratio (ratio of outlet to inlet pressure) may be selected in the range between 11 and 39 for a low pressure compressor of a two-stage turbo-machinery and at a level of at least 39 for a one-stage turbo-machinery. Thereby the higher the desirable air temperature is at the compressor 201 outlet, the higher should be its selected compressor ratio. The high pressure air compressor 202 may include an uncooled (adiabatic) industrial compressor selected to provide a compression ratio between 1.2 and 6.5 at a predefined charging air pressure at its outlet. The higher a selected compression ratio is in the low pressure compressor 201, the lower a compression ratio is of the high pressure compressor 202, according to preferred configurations.

Here, and in various embodiments, the hot thermal energy storage unit 300 may be configured as a combination of at most two hot thermal energy storage stages 301 and 302, installed correspondingly downstream of the compressors 201 and 202. Thereby, a one-stage hot thermal energy storage 301 may be used as applied to the one-stage adiabatic compression of the charging air. In various embodiments, a two-stage storage configuration may be used with the two-stage semi-adiabatic compression of the charging air and includes the first storage stage 301 and the second storage stage 302. The hot storages may employ preferably a solid storing medium or a liquid medium for sensible heat storage. During LAES charging, the selected medium directly (or indirectly, using an internal heat transfer device such as a heat exchanger) exchanges thermal energy with the pressurized charging air and stores the captured heat for its further recovery during LAES discharge.

A hot thermal energy storage 301 with the integrated air aftercooler/intercooler 303 may be used as air aftercooler in the case of one-stage adiabatic compression of the charging air, and as air intercooler in the case of two-stage semi-adiabatic compression of the charging air. In any case this storage provides a decrease in charging air temperature from 350-580° C. at the outlet of the compressor 201 down to 40-60° C. at the outlet of aftercooler/intercooler 303. A hot thermal energy storage 302 with the integrated aftercooler 304 may be used in the case of two-stage semi-adiabatic compression of the charging air to provide a decrease in its temperature down to 40-120° C. at the outlet of aftercooler 304.

The first and second hot thermal energy storages 301 and 302 may be equipped with the downstream installed air or water-cooled balance heat exchangers 305 and 306 with the drainage of atmospheric moisture from the pressurized charging air. A target air temperature at the outlet of balance heat exchangers may be set at a level of 30° C., required to provide a proper operation of the downstream installed adsorber unit 400 and cryogenic unit 500.

The adsorber unit 400 removing the CO₂ components and remaining atmospheric moisture from the cooled and pressurized charging air stream may be installed downstream of the balance heat exchanger 305. The adsorber unit 400 may comprise one pressurized pre-purifying vessel with at most two beds of industrial adsorbent, using known principles of physical adsorption for simultaneous or separate and successive removal of the identified components. The type of the adsorbent and the selected mechanism for its regeneration may be selected in accordance with a temperature of discharged air at the outlet of low pressure expander 1002. In various embodiments, this temperature is high enough for thermal regeneration of sorbent, which may be performed during system discharge. In some embodiments, temperature swing adsorption (TSA) and/or pressure assisted temperature swing adsorption (PA-TSA) types of adsorbent used for the treatment of charging air in the proposed LAES system. Thermal regeneration of adsorbent is detailed below.

The cryogenic unit 500 may be installed downstream of the balance heat exchanger 305 (as shown in the FIG. 1B) or after the balance heat exchanger 306. In various embodiments in which the cryogenic unit 500 is installed after the balance heat exchanger 306, the cryogenic unit 500 may be selected to increase a temperature level of hot thermal energy stored in the second storage 302 and/or to use an advanced PA-TSA sorbent instead of TSA one. But a possibility for such arrangement of the cryogenic unit is limited by a value of the maximum allowable pressure in the adsorber vessel. In either case the cryogenic unit 500 may be used to further decrease the temperature of the charging gaseous air stream, its full liquefaction and further cooling the liquid air down to a rated temperature, using a combined cold capacity of the vapor cold exchanger 510 and cold thermal energy storage 520.

In some embodiments, the cold thermal energy storage 520 may be embodied as a combination of two in-series cold thermal energy storages 521 and 522 in which the first cold thermal energy storage 521 is arranged in-parallel with a vapor cold exchanger 510. The first cold thermal energy storage cools 94-96% of charging air stream delivered to the cryogenic unit 500. The remainder of the charging air stream (4-6%) is cooled in the vapor cold exchanger 510. The controlled stream divider 541 at the inlet of cryogenic unit 500 performs partitioning the charging air stream in a predefined proportion between the vapor cold exchanger 510 and cold thermal energy storage 521, whereas an uncontrolled mixer 542 combines the streams escaping the first cold thermal energy storage 521 and vapor cold exchanger 510 and directs a mixed stream towards the second cold thermal energy storage 522. A fractional load of each cooling element in the combined cold capacity of the cryogenic unit 500 may be varied somewhat according to the charging air pressure as follows: the cold thermal energy storage 521: 57-59%, the cold thermal energy storage 522: 39-40%, and the cold exchanger 510: 2-3%.

The LAES system may be configured, according to respective embodiments, to exhibit the following parameters of the cryogenic unit 500 in the all ranges here and elsewhere being specified as inclusive ranges (i.e., including the identified end points): a rated temperature of the fully liquefied charging air stream at the outlet of the cold thermal energy storage 522 during LAES charge, in the range between −185° C. and −187° C.; a rated air liquefaction ratio of the discharged air mass flow-rate to charging air mass flow-rate, in the range between 95 and 96%; a rated difference in temperature (ΔT2_{CH-DISCH}) of the fully liquefied charging air stream at the outlet of the cold thermal energy storage 522 during LAES charge and of the liquid discharged air stream at the inlet of the cold thermal energy storage 522 during LAES discharge, in the range between 3 and 5° C.; a difference in temperature (ΔT1_{CH-DISCH}) of the charging air stream at the inlet of the cold thermal energy storage 521 during LAES charge and of the fully re-gasified discharged air stream at the outlet of the cold thermal energy storage 521 during LAES discharge, selected in the range between 1 and 13° C. and depending on the cold thermal energy storage configuration and a desirable round-trip efficiency of the LAES system; and a relationship (P_{CH}/P_{DISCH}) between a pressure (P_{CH}) of the charging air stream at the inlet of the cold thermal energy storage 521 during LAES charge and a pressure (P_{DISCH}) of the discharged air stream at the inlet of the second cold thermal energy storage 522 during LAES discharge, selected in the range from 1.15 to 3.35, depending on the rated difference in temperature ΔT1_{CH-DISCH} of the charging and discharged air streams. Thereby, the lower is a selected ΔT1_{CH- DISCH}, the lower could be a P_{CH}/P_{DISCH} value selected.

In some embodiments, the first and second cold thermal energy storages 521 and 522 may comprise a solid thermal storage medium which directly exchanges thermal energy with the charging air stream being cooled during LAES charge periods and with the discharge air stream being heated during LAES discharge periods. The choice of a solid cold thermal energy storage medium may permit the selection of lower values of a rated difference in temperatures ΔT_{CH-DISCH} of the charging and discharged air streams, resulting in a significant increase in LAES round-trip efficiency. Alternatively, a liquid cold thermal energy storage medium may be employed in both storages 521 and 522, wherein this medium indirectly exchanges thermal energy with the charging and discharged air streams and is used for storing a captured thermal energy. Finally, either of the two cold thermal energy storages 521 and 522 may be designed as the partitioned into the separate, placed in-series modules filled with the different solid as well as liquid cold thermal storage media, possessing the different thermodynamic properties and providing direct or in-direct, single-phase or two-phase thermal energy transfer.

The liquid air expander 600 and liquid air separator 700 may be selected to reduce a pressure and temperature of the liquefied charging air sequentially down to the values in the range between 1.29 and 1.35 barA, respectively, and −191.7 and −192.1° C., respectively, at the outlet of the liquid air separator 700. Thereby, a stable operation of the liquid air expander 600 is provided through maintaining a vapor phase of the charging air stream at its outlet in the range between 0 and 0.5%, whereas a share of vent vapor stream escaping liquid air separator 700 does not exceed 4-5% of the full mass flow-rate of charging air at its inlet. With these constraints, a rated air liquefaction ratio of the LAES system in the range between 95-96% is provided.

The liquid air storage unit 800 may include one or several heavily insulated tanks and be configured for storing liquid air under the conditions close to the air pressure and temperature at its inlet. A daily operation of the LAES system and a corresponding short-term storing the liquid air in the storage unit 800 result in the negligible losses of stored air mass, which may be limited to 0.25 and 0.5% per day. Optionally, air vented from the liquid storage may be used to further cool the first cold thermal storage 521 between the LAES charge and discharge periods, resulting in desirable reducing the difference in temperature ΔT1_{CH-DISCH} of the charging and discharged air streams in the cryogenic unit 500.

The liquid air pump 900 may be selected to increase pressure of the discharged air captured from the liquid air storage unit 800 during LAES discharge periods, to subcritical or supercritical value (P_{DISCH}) in accordance with a selected value of the pressure relationship P_{CH}/P_{DISCH}. It should be taken into account that the higher is a pressure P_{DISCH} at the pump 900 outlet, the higher is the liquid air temperature at its outlet. This may result in decreasing a difference in temperature ΔT2_{CH-DISCH} below a rated value. However, the mentioned low temperatures of liquid air in the storage 800 and at the pump 900 inlet provide a required rated temperature difference ΔT2_{CH-DISCH} at any selected discharged air pressure P_{DISCH}.

As mentioned above, the cryogenic unit 500 may be configured to achieve predefined difference in temperature ΔT1_{CH-DISCH} of the charging air stream at the inlet of the cold thermal energy storage 521 during LAES charge and of the fully evaporated discharged air stream at the outlet of the cold thermal energy storage 521 during LAES discharge. For embodiments with a ΔT1_{CH-DISCH} value in the range between 1 and 13° C. and an inlet temperature of the charging air stream of 30° C., an outlet temperature of the discharged air stream in the range between 17 and 29° C. may be provided.

FIG. 1B shows the preferable embodiment of the present invention, wherein the expander unit 1000 represents a dynamic turbo-machinery, providing at most two-stage expansion of the discharged air from a selected subcritical or supercritical pressure down to one close to atmospheric. At a pressure of charging air at the outlet of high pressure compressor 202 below than 55 barA and simultaneously at a temperature of charging air at the outlet of low pressure compressor 201 higher than 500° C., the air expander unit 1000 may be preferably designed as a one-stage adiabatic turbo-machinery with upstream installed air superheater 307. In other cases, the expander unit 1000 may include a two-stage semi-adiabatic turbo-machinery, combining the high and low pressure adiabatic expanders 1001 and 1002 placed in-series and equipped with the air superheater 307 and air reheater 308. The air superheater and reheater may be integral parts of the hot storages 301 and 302, providing a recovery of hot thermal energy for superheating and reheating the discharged air stream. The expanders 1001 and 1002 may be configured as multiple expanders placed in-parallel and providing a required summary capacity. This arrangement may be particularly suitable for system exceeding 100-300 MW of power capacity.

The expander 1001 may include an adiabatic turbo-machinery for operation at a maximum possible air temperature at its inlet, resulting in a significant increase in the LAES round-trip efficiency. Over all range of the possible discharged air pressures at the inlet of expander 1001 it may be designed as an industrial expander, admitting adiabatic expansion at an inlet air temperature up to about 500° C. At the moderate discharged air pressure the expander 1001 may include the modified high pressure gas turbines, admitting an inlet air temperature well above 550° C. The expander 1001 may also employ modified steam turbines, admitting very high inlet air pressure at the temperatures between 500 and 600° C.

An enhanced round-trip efficiency of the disclosed LAES systems, being operated at the P_{CH} values up to 75 barA and with the pressure relationship P_{CH}/P_{DISCH}=1.15-3.35, may be provided through an expansion ratio of the expander 1001 selected in the following ranges: between 9.5 and 10.5 for the case of charging air temperature at the outlet of compressor 201 in the range from 300 to 400° C.; between 16.5 and 19 for the case of charging air temperature at the outlet of compressor 201 in the range from 400 to 500° C.; and between 27.5 and 42.5 for the case of charging air temperature at the outlet of compressor 201 in the range from 500 to 575° C.

The low pressure expander 1002 operated at the moderate inlet pressure and temperature of the discharged air may employ the industrial expanders adapted for adiabatic expansion of discharged air at its inlet temperature up to 300-350° C. An enhanced round-trip efficiency of the disclosed LAES systems, being operated at the P_{CH} values up to 75 barA and with the pressure relationship P_{CH}/P_{DISCH}=1.15-3.35, may be provided through an expansion ratio of the expander 1002 selected in the following ranges: between 3.5 and 6.5 for the case of charging air temperature at the outlet of compressor 201 in the range from 300 to 400° C.; between 1.5 and 3.5 for the case of charging air temperature at the outlet of compressor 201 in the range from 400 to 500° C.; and between 1.1 and 2.5 for the case of charging air temperature at the outlet of compressor 201 in the range from 500 to 575° C.

In various embodiments, the piping 1100 may be used for adsorber bed thermal regeneration during LAES discharge periods and include the piping 1101 used for delivery the CO₂ and moisture-free discharged air as heating gaseous stream from exhaust of the expander train to the bed of adsorber unit 400 and the piping 1102 used for removal of this stream together with CO₂ and atmospheric moisture from the adsorbent bed into atmosphere.

In some embodiments, the placement of the adsorber unit 400 and the connections of piping 1101 and 1102 are correlated with temperature and pressure parameters, as identified in FIG. 1C, described below.

FIG. 1C is a table 30 illustrating various configurations of LAES systems with two-stage semi-adiabatic compression of the charging air, according to one or more embodiments of the disclosed subject matter. Table 30 describes configurations including the placement of the adsorber unit 400 and the connections of piping 1101 and 1102 are correlated with temperature and pressure parameters. The parameters include a temperature of charging air at the outlet of low pressure compressor 201 (TLPC-OUT) and a pressure ratio of charging air at the outlet of low pressure compressor 201 (PLPC-OUT) and of discharge air at the inlet of low pressure expander 1002 (PLPE-IN). In FIG. 1C, the possible connections of piping 1101 are indicated by AROUT for delivery of purging air from an outlet of the air reheater 308 and by LPEOUT for delivery of purging air from an outlet of the low pressure air expander 1002. The possible connections of piping 1102 are indicated by LPEIN for removal of purging air to an inlet of the low pressure air expander 1002 and by LAESEXH for removal of purging air to an exhaust of the LAES system.

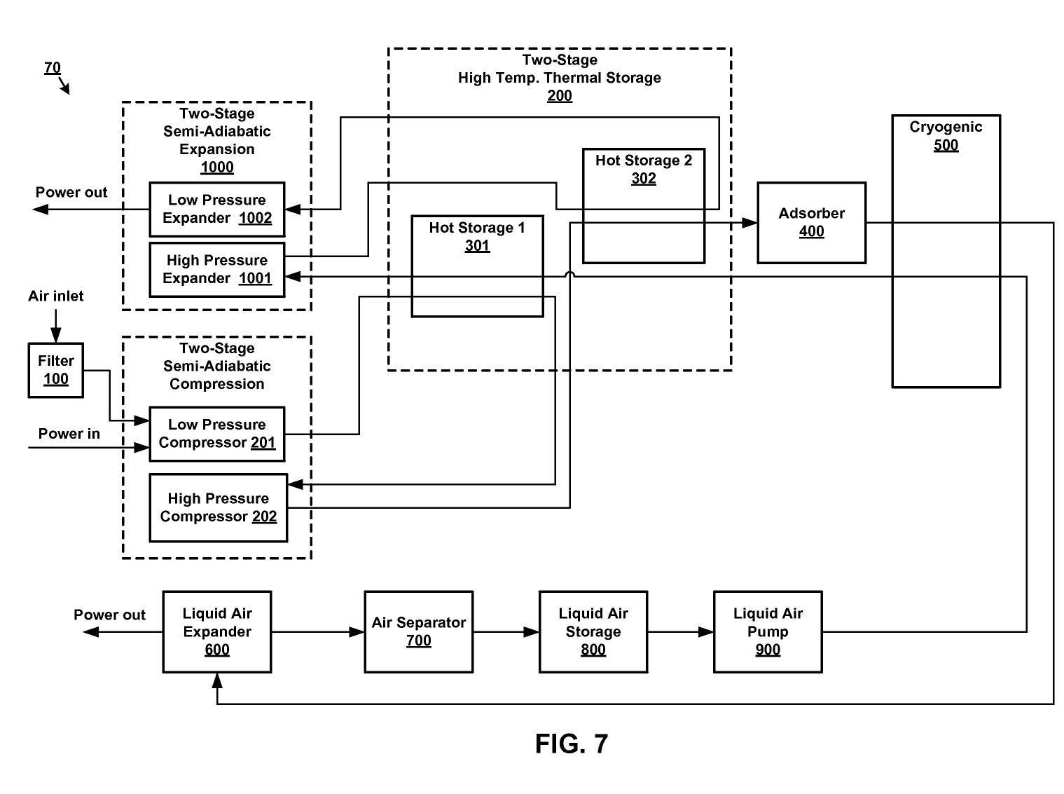

In some embodiments, as indicated above, the adsorber unit 400 may be positioned between the balance heat exchanger 305 and high pressure air compressor 202, as shown in FIG. 1B or between the balance heat exchanger 306 and cryogenic unit 500, as shown in FIG. 7. To define advantageous embodiments, these adsorber position alternatives are also combined with the connections of the piping 1101 and 1102 and correlated with the air parameters identified above in FIG. 1C. The embodiment shown in FIG. 1B corresponds to the third (No. 3) adsorber regeneration alternative and is presented by a placement of adsorber 400 with PA-TSA adsorbent between the balance heat exchanger 305 and high pressure air compressor 202 with a connection LPEOUT of piping 1101 at the outlet of low pressure expander 1002 and a connection LAESEXH of piping 1102 at the exhaust of the LAES system. The selected air parameters of TLPC-OUT and PLPC-OUT/PLPE-IN are, as indicated in alternative No. 3, between 400 to 500° C. and between 4 to 8, respectively. The presented adsorber regeneration alternatives define embodiments by correlating possible placements of adsorber unit 400 and the connections of piping 1101 and 1102 with respect to the identified parameters of the charging and discharge air.

FIG. 7 illustrates a LAES system 70 with two-stage semi-adiabatic compression of the charging air and an adsorber 400 installed between second high temperature storage stage 302 and cryogenic unit 500, according to one or more embodiments of the disclosed subject matter. System 70 illustrates configuration Nos. 2 and/or 4 described in table 30 of FIG. 1C discussed above.

The disclosed LAES systems can be characterized by an enhanced round-trip efficiency, resulting from a possibility to thoroughly and markedly increase a pressure and temperature of the discharged air stream during the LAES discharge phase.

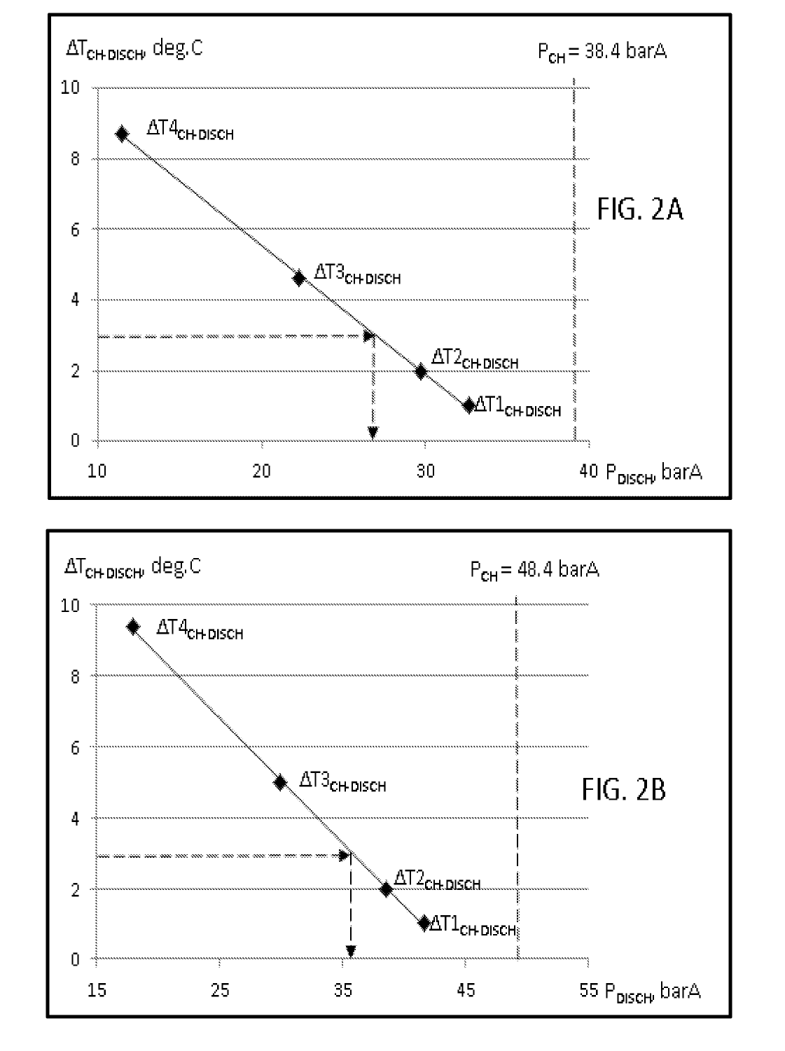

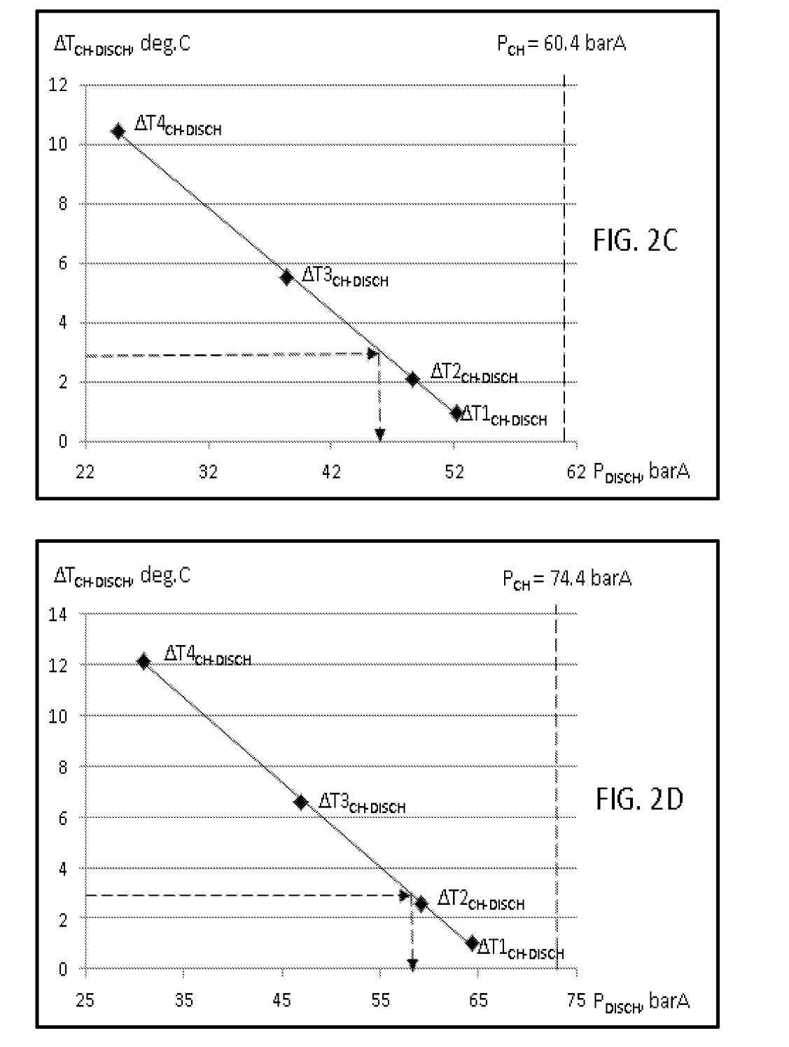

According to the embodiments, for any given charging air pressure (P_{CH}) an advantageous discharge air pressure (P_{DISCH}) is provided in the proposed system by minimizing the P_{CH}/P_{DISCH} relationship at a rated difference in temperature (ΔT_{CH-DISCH}) of the charging air stream provided at the inlet of the cold thermal energy storage 521 during LAES charge and of the fully re-gasified discharged air stream at the outlet of the first cold thermal energy storage 521 during LAES discharge. This is shown by the graphs presented in the FIGS. 2A-2D.

For example, as seen in FIG. 2A, for the given charging air pressure P_{CH}=38.4 barA at the cryogenic unit 500 inlet and selected value of ΔT_{CH-DISCH}=3° C. a balance between the required and available cold capacities in the proposed cryogenic unit 500 may be provided at the minimum value of P_{CH}/P_{DISCH}=1.43, corresponding the greatest value of discharged air pressure P_{DISCH}=26.8 barA at the cryogenic unit 500 inlet. This result may be obtained in a full accordance with the previously-defined (rated) design parameters of the cryogenic unit 500, namely: a temperature of the liquid charging air stream at the outlet of the cold thermal energy storage 522 during LAES charge is equal to −186.3° C. and lies within the rated range from −187° C. and −185° C.; an air liquefaction ratio as a relationship between the mass flow-rates of the discharged and charging air is equal to 95.2% and lies within the rated range 95<96%; and a rated difference between the temperature of the liquid charging air stream at the outlet of the second cold thermal energy storage 522 during LAES charge and the temperature of the liquid discharged air stream at the inlet of the second cold thermal energy storage 522 during LAES discharge is equal to 4.6° C. and lies within the rated range 3-5° C.

As shown in the FIGS. 2B, 2C and 2D, the minimal values of pressure relationship P_{CH} P_{DISCH} and corresponding greatest possible discharged air pressures P_{DISCH} may be determined in a similar way for three other given charging air pressures P_{CH}=48.4, 60.4 and 74.4 barA at the same selected value of ΔT_{CH-DISCH}=3° C. These are equal to P_{DISCH}=35.6, 45.9 and 57.7 barA, respectively.

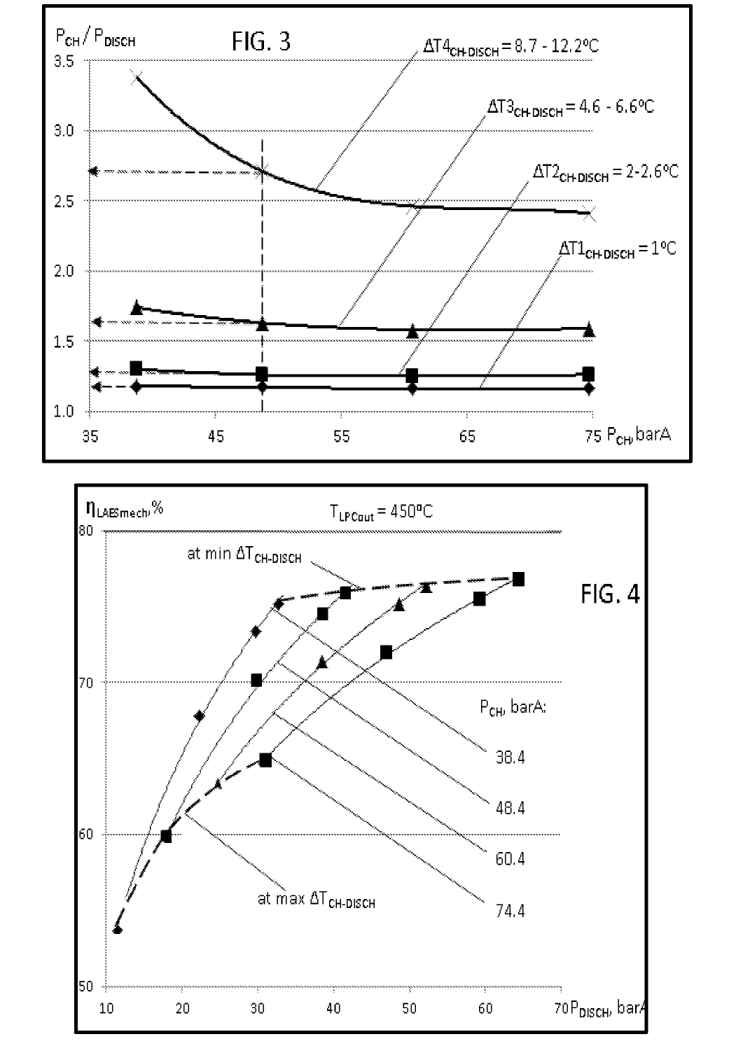

FIG. 3 is a graph showing the summary interrelationship between charging and discharged air pressures at the rated differences in their temperature at the cryogenic unit inlet, according to one or more embodiments of the disclosed subject matter. The graph shows the summary relationship between charging and discharged air pressures at the selected differences in their temperature (ΔT1_{CH-DISCH}) at the inlet of cryogenic unit 500. From this graph it is clear, that for any given charging air pressure (for example, P_{CH}=48.4 barA) a desirable increase in discharged air pressure P_{DISCH} (for example, from its minimum value of 17.9 barA up to its maximum value of 41.7 barA) may be achieved through a decrease in pressure relationship P_{CH}/P_{DISCH} from its maximum value of 2.70 down to its minimum value of 1.16. In providing this, an increase in P_{DISCH} value makes possible to enhance a LAES round-trip efficiency and profitability of the LAES system. However, a selected difference in temperature ΔT_{CH-DISCH} in such cryogenic unit 500 must be decreased from a maximum value of ΔT4_{CH-DISCH}=9.4° C. down to a minimum value of ΔT1_{CH-DISCH}=1° C. Hence, a tradeoff is that a selection of the decreased ΔT_{CH-DISCH} value complicates design of the cryogenic unit 500 and leads to an increase in the LAES first cost.

FIG. 4 is a graph showing an impact of the selected discharged air pressure on the LAES round-trip efficiency, according to one or more embodiments of the disclosed subject matter. This graph shows an impact of the discharge air pressure (P_{DISCH}) on the LAES round-trip efficiency (η_{LAES}). Calculations have been performed for the constant charging air temperature (T_{LPCout}=450° C.) at the outlet of low pressure compressor 201 and without regard to the losses in electrical machines. From this graph it can be seen that selecting the reduced values of differences in temperature ΔT_{CH-DISCH} accompanied by a corresponding increase in the P_{DISCH} value at the any given and constant P_{CH} value leads to an increase in the LAES system efficiency. The rise in η_{LAES} value by a similar way may be first of all recommended in the LAES systems operated at the reduced pressures of charging air (P_{CH}=38.4-48.4 barA). Here a decrease in the selected ΔT_{CH-DISCH} value from maximum (8.7-9.4° C.) to minimum (1° C.) accompanied by a corresponding increase in the P_{DISCH} value by 21.3-23.7 barA make possible to increase a LAES round-trip efficiency by 21.5-16.1%. In the area of the enhanced P_{CH} values (60.4-74.4 barA) a similar decrease in the selected ΔT_{CH-DISCH} values from maximum (10.5-12.1° C.) to minimum (1° C.) is accompanied by a corresponding increase in the P_{DISCH} values by 27.5-33.4 barA and makes possible to increase a LAES round-trip efficiency by a lesser magnitude of 13.1-11.9%.

In addition, from analysis of the graph in the FIG. 4 it is clear that an impact of P_{DISCH} value on the LAES system efficiency is strongly dependent on a region of selected ΔT_{CH-DISCH} values where this impact is considered. In a region of the maximum ΔT_{CH-DISCH} values (from 8.7 to 12.1° C.) an increase in P_{DISCH} value by 19.5 barA (from 11.5 to 31 barA) together with a corresponding increase in the P_{CH} values (from 38.4 to 74.4 barA) cause a rise in η_{LAES} value by 11.2%. At the same time, in a region of the minimum ΔT_{CH-DISCH} values (1° C.) a similar increase in P_{DISCH} value by 31.7 barA from 32.7 to 64.4 barA) together with a corresponding increase in the P_{CH} values (from 38.4 to 74.4 barA) lead to rising a η_{LAES} value by 1.6% only.

FIG. 5 is a graph showing an impact of the selected air temperature at the low pressure compressor outlet and selected air pressure at the high pressure compressor outlet on the LAES round-trip efficiency at the maximum value of discharged air pressure, according to one or more embodiments of the disclosed subject matter. This graph shows an impact of the charging air temperature T_{LPCout} at the outlet of low pressure compressor 201 and charging air pressure P_{HPCout} on the LAES round-trip efficiency Θ_{LAES} at the maximum values of discharged air pressure P_{DISCH}, resulting from the minimum selected value of ΔT_{CH-DISCH}=1° C. and corresponding minimum value of the relationship P_{CH}/P_{DISCH}=1.165. As shown in the FIG. 5, the increase in temperature T_{LPCout} of charging air at the outlet of low pressure compressor 201 from 350° C. to 550° C. leads to a marked increase in the LAES round-trip efficiency by 1.4-1.8% practically over a whole range of the possible pressures of charging air P_{HPCout} at the outlet of high pressure compressor 202 from 38.7 to 74.7 barA. In its turn, an increase in P_{HPCout} value in the mentioned boundaries leads to enhancement of LAES round-trip efficiency by 1.2-1.6% practically over a whole range of the possible temperatures of charging air T_{LPCout} at the outlet of low pressure compressor 201 from 350 to 550° C.

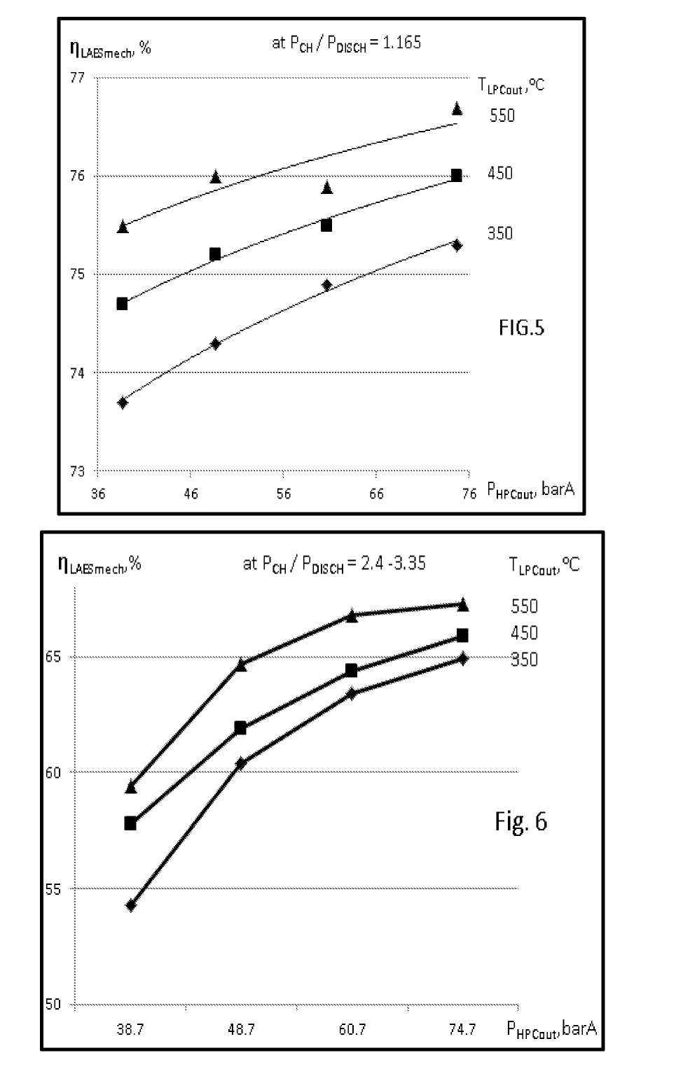

FIG. 6 is a graph showing an impact of the selected air temperature at the low pressure compressor outlet and selected air pressure at the high pressure compressor outlet on the LAES round-trip efficiency at the minimum values of discharged air pressure, according to one or more embodiments of the disclosed subject matter. This graph shows an impact of the air temperature T_{LPCout} at the outlet of low pressure compressor 201 and charging air pressure P_{HPCout} on the LAES round-trip efficiency η_{LAES} at the minimum values of discharge air pressure P_{DISCH}, resulting from the maximum selected values of ΔT_{CH-DISCH}=8.8-12.2° C. and corresponding maximum values of the relationship P_{CH}/P_{DISCH} between 2.4 and 3.35. As shown in the FIG. 6, the increase in temperature T_{LPCout} of charging air at the outlet of low pressure compressor 201 from 350° C. to 550° C. leads to a greater enhancement of the LAES round-trip efficiency by 2.4-5.1%, especially prominent in the range of the reduced pressures of charging air P_{HPCout} at the outlet of high pressure compressor 202. Therefore, application of the proposed improvements can best be done first of all in the liquid air energy storages with the reduced pressures of charging air P_{HPCout} and elevated differences in temperature (ΔT_{CH-DISCH}) of the charging and discharged air streams.

In one or more first embodiments, a liquid air energy storage (LAES) system comprises in combination a compressor unit, a hot thermal energy storage unit, an adsorber unit, a cryogenic unit, a liquid air expander unit, a liquid air separator unit, a liquid air storage unit, a liquid air pump unit, an expander unit, and piping. The compressor unit can provide compression of a charging air up to a pressure above a critical value. The hot thermal energy storage unit can be adapted to capture and store compression heat. The adsorber unit can provide physical adsorption of the CO₂ and atmospheric moisture from a pressurized charging air and regeneration of sorbent bed by purging discharge air. The cryogenic unit can be adapted to liquefaction of the pressurized charging air by capturing a cold thermal energy from a cold storing media in an integrated cold thermal energy storage and from a cold vaporized air stream in an integrated vapor cold exchanger. The liquid air expander unit can provide depressurization of the liquified charging air. The liquid air separator unit can provide further depressurization and separation of the charging air into liquid air and vapor streams. The liquid air storage unit can provide storage of a liquid air between the LAES charge and discharge periods. The liquid air pump unit can provide delivery of a discharge air into the cryogenic unit at a selected discharge pressure. The cryogenic unit can be adapted to cause evaporation of the pressurized discharge air by transfer of its cold thermal energy into a cold storing media in the integrated cold thermal energy storage. The hot thermal energy storage unit can be adapted to recovery of stored compression heat for preheating and reheating the pressurized discharge air. The expander unit can provide expansion of the pressurized discharged air up to a selected exhaust pressure at its outlet. The piping can provide delivery of purging discharge air to the bed of the adsorber unit and removal of this stream together with CO₂ and atmospheric moisture from the adsorbent bed. The compressor unit can include a combination of at most two placed in-series adiabatic compressors providing a pressure of the charging air at the outlet of compressor unit in the range from 39 to 80 barA with a compression ratio of the one-stage compressor set up at a level of at least 39 or a compression ratio of the first stage compressor selected in the range from 11 to 39. The expander unit can include a combination of at most two placed in-series adiabatic expanders providing an expansion ratio of the first stage expander between 9 and 43 and expansion of air in the two-stage or a single one-stage expanders from a selected discharge air pressure down to a selected exhaust pressure exceeding an atmospheric pressure by 0.05-0.1 bar at most. The hot thermal energy storage unit can include a combination of at most two hot thermal energy storages in which a single or the first storage is adapted to capture and store a compression heat generated correspondingly by a single one-stage or the first stage compressors and to recover a stored compression heat by a single one-stage or the first stage expanders correspondingly, whereas the second storage is adapted to capture and store a compression heat generated by the second stage compressor and to recover a stored compression heat by the second stage expander. The liquid air pump unit can pump a discharge air from a liquid air storage unit at a selected pressure providing a relationship between the pressures of the charging air at the inlet of the cryogenic unit during LAES charge phase and of discharge air stream at the inlet of the cryogenic unit during LAES discharge phase in the range from 1.15 to 3.35. The cryogenic unit can provide a difference in temperature of the charging air stream at the inlet of the unit during LAES charge phase and of the discharge air stream at the outlet of the unit during LAES discharge phase selected in the range from 1 to 13° C. The cryogenic unit can provide a lesser value of a relationship between the pressure of the charging and discharge air streams at a lesser value of the difference in temperature of the charging and discharge air streams at a rated air liquefaction ratio of 95-96% and a rated difference in 3-5° C. between the temperatures of charging air at the outlet of the cryogenic unit and of discharge air at the inlet of the cryogenic unit.

In the first embodiments or any other of the disclosed embodiments, the compressor unit can be a one-stage adiabatic turbo-machinery, including the placed in-series one-stage adiabatic compressor, single aftercooler and single balance heat exchanger, and providing the temperatures of charging air at the outlet of the equipment in the following ranges: 350-580° C., 40-60° C., and at most 30° C.

In the first embodiments or any other of the disclosed embodiments, the compressor unit can be a two-stage semi-adiabatic turbo-machinery, including the placed in-series low pressure adiabatic compressor, intercooler, first balance heat exchanger, high pressure adiabatic compressor, aftercooler and second balance heat exchanger, and providing the temperatures of charging air at the outlet of the equipment in the following ranges: 350-580° C., 40-60° C., at most 30° C., 260-40° C., 40-120° C. and at most 30° C., correspondingly.

In the first embodiments or any other of the disclosed embodiments, the compressor unit can be either a one-stage adiabatic compressor or a two-stage semi-adiabatic compressor each designed as a set of the multiple adiabatic compressors placed in-series to achieve a predefined ultimate compression ratio.

In the first embodiments or any other of the disclosed embodiments, the compressor unit can be a two-stage semi-adiabatic turbo-machinery, providing a charging air pressure at the outlet of high pressure compressor below 55 barA and a charging air temperature at the outlet of low pressure compressor above 500° C., whereas the expander unit is a one-stage adiabatic expander.

In the first embodiments or any other of the disclosed embodiments, the expander unit can be a one-stage adiabatic turbo-machinery, including the placed in-series discharge air preheater and an adiabatic expander.

In the first embodiments or any other of the disclosed embodiments, the expander unit can be a two-stage semi-adiabatic turbo-machinery, including the placed in-series discharge air preheater, high pressure adiabatic expander, discharge air reheater and low pressure adiabatic expander, and providing an expansion ratio of the high pressure expander selected in the following ranges: between 9.5 and 10.5 for the case of charging air temperature at outlet of the first stage compressor in the range from 300 to 400° C.; between 16.5 and 19 for the case of charging air temperature at outlet of the first stage compressor in the range from 400 to 500° C.; and between 27.5 and 42.5 for the case of charging air temperature at outlet of the first stage compressor in the range from 500 to 575° C.

In the first embodiments or any other of the disclosed embodiments, the expander unit can be either a one-stage adiabatic expander or a two-stage semi-adiabatic expander each designed as a set of the multiple adiabatic expanders placed in-series to achieve a predefined ultimate expansion ratio.

In the first embodiments or any other of the disclosed embodiments, the compressor and/or expander units can be the set of the multiple compressor and/or expander unit(s) placed in parallel to achieve a predefined ultimate total output of the large-scale LAES systems exceeding 100 MW of discharged power.

In the first embodiments or any other of the disclosed embodiments, the single hot thermal energy storage can be integrated with the discharge air preheater and the charging air aftercooler, the first hot thermal energy storage is integrated with the discharge air preheater and the charging air intercooler, and the second hot thermal energy storage is integrated with the discharge air reheater and the charging air aftercooler, whereas a heat storing media for any the hot thermal energy storage is selected from the group including solid, liquid, phase-change materials and combination thereof, providing a direct or indirect exchange of thermal energy stored by this media with the charging and discharge air streams.

In the first embodiments or any other of the disclosed embodiments, the charging air intercooler can be integrated with the rear-mounted first balance water-or air-cooled heat exchanger and the charging air aftercooler is integrated with the rear-mounted single or second balance water-or air-cooled heat exchanger, whereas any the balance water-or air-cooled heat exchanger is equipped with the required condensate drainage devices.

In the first embodiments or any other of the disclosed embodiments, the adsorber unit can be one pressurized vessel with at least one bed of the known industrial adsorbent, type of which and adsorber placement in the LAES system with two-stage compressor are selected with regard to a temperature of charging air at the outlet of a low pressure compressor.

In the first embodiments or any other of the disclosed embodiments, a placement of the adsorber unit with an industrial sorbent providing a temperature swing adsorption of contaminants can be selected between the first balance heat exchanger and the high pressure compressor for a charging air temperature at the outlet of the low pressure compressor in the range between 350 and 400° C.

In the first embodiments or any other of the disclosed embodiments, a placement of the adsorber unit with an industrial sorbent providing a pressure swing adsorption of contaminants can be selected between the second balance heat exchanger and the cryogenic unit for a charging air temperature at the outlet of the low pressure compressor in the range between 500 and 550° C.

In the first embodiments or any other of the disclosed embodiments, a placement of the adsorber unit and a type of an industrial sorbent used can be selected with regard to a relationship between the pressures of charging air at the outlet of low pressure compressor and of discharged air at the inlet of low pressure expander for a charging air temperature at the outlet of the low pressure compressor in the range between 400 and 500° C.

In the first embodiments or any other of the disclosed embodiments, a placement of the adsorber unit with an industrial sorbent providing a pressure assisted temperature swing adsorption of contaminants can be selected between the first balance heat exchanger and the high pressure compressor for the pressure relationship between 4 and 8.

In the first embodiments or any other of the disclosed embodiments, a placement of the adsorber unit with an industrial sorbent providing a temperature assisted pressure swing adsorption of contaminants can be selected between the second balance heat exchanger and the cryogenic unit for a pressure relationship between 8 and 12.

In the first embodiments or any other of the disclosed embodiments, the cryogenic unit can be a combination of the cold thermal energy storage, partitioned into placed in-series first and second storages, providing 57-59% and 39-40% respectively of a total cold capacity of the cryogenic unit, and the vapor cold exchanger, arranged in parallel with the first storage and providing up to 3% of total cold capacity of cryogenic unit.

In the first embodiments or any other of the disclosed embodiments, the cryogenic unit can be equipped with a controlled divider installed at the inlet of unit and intended for separating a mass flow of charging air between the first cold storage and the vapor cold exchanger in the proportion (94-96)% to (6-4)% and with an uncontrolled mixer installed upstream of the second cold storage and intended for mixing the charging air streams escaping the first cold storage and the vapor cold exchanger.

In the first embodiments or any other of the disclosed embodiments, the first cold storage and vapor cold exchanger can be adapted to deeply cool the passing charging air down to −120-−140° C., whereas the second cold storage is adapted to liquefy and subcool the full charging air flow down to −186-−187° C.

In the first embodiments or any other of the disclosed embodiments, the means of compensation for thermal and mass operational losses can inlcude the compressor unit providing a mass flow of charging air increased by 0.25-0.5% and a balance cold exchanger integrated with the cryogenic unit and supplied with an appropriate cold carrier, which is generated by an external cold source consuming a power from the grid for its operation.

In the first embodiments or any other of the disclosed embodiments, the cryogenic unit can be a combination of the cold thermal energy storage, partitioned into placed in-series first and second storages, providing 52-58% and 35-38% respectively of a total cold capacity of the cryogenic unit, and the balance and vapor cold exchangers, both arranged in parallel with the first storage and providing 1-11% and up to 3% of total cold capacity of cryogenic unit respectively.

In the first embodiments or any other of the disclosed embodiments, the cryogenic unit can be equipped with a controlled divider installed at the inlet of unit and intended for separating a mass flow of charging air between the first cold storage and the vapor and balance cold exchangers in the proportion (84-94)%:(6-4)%:(1-11)% and with an uncontrolled mixer installed upstream of the second cold storage and intended for mixing the charging air streams escaping the first cold storage and the vapor and balance cold exchangers.

In the first embodiments or any other of the disclosed embodiments, the first cold storage and the vapor and balance cold exchangers can be adapted to deeply cool the passing charging air down to −120-−140° C., whereas the second cold storage is adapted to liquefy and subcool the full charging air flow down to −186-−187° C.

In the first embodiments or any other of the disclosed embodiments, a cold storing media for the cold thermal energy storage is selected from the group including solid, liquid, phase-change materials and combination thereof, providing a direct or indirect exchange of thermal energy stored by this media with the charging and discharge air streams.

In the first embodiments or any other of the disclosed embodiments, either of the two or both cold storages can be designed as the partitioned into the separate, placed in-series modules filled with the different solid, liquid or phase-change cold storage media, possessing the different thermodynamic properties and providing a direct or in-direct thermal energy transfer with the charging and discharge air streams.

In the first embodiments or any other of the disclosed embodiments, the liquid air expander unit can provide a share of vapor phase in the charging air stream at its outlet in the range between 0 and 0.5%.

In the first embodiments or any other of the disclosed embodiments, the liquid air separator unit can be designed to provide the rated air liquefaction ratio by setting the temperature and pressure of the vapor and liquid phases of a charging air stream at its outlet in the range from 1.29 and 1.35 barA and between −191.7 and −192.1° C. correspondingly.

In the first embodiments or any other of the disclosed embodiments, the liquid air storage unit is can be designed as one or several well-insulated tanks providing storage of liquid air with the evaporation losses not exceeding 0.25-0.5% per day.

In the first embodiments or any other of the disclosed embodiments, the system can include piping connections, wherein an inlet connection of the piping delivering the purging air to the adsorber bed for its regeneration can be an outlet of the discharge air reheater and an outlet connection of the piping removing the purging air from the adsorber is an inlet of the low pressure air expander.

In the first embodiments or any other of the disclosed embodiments, the system can include piping connections, wherein an inlet connection of the piping delivering the purging air to the adsorber bed for its regeneration is an outlet of the low pressure expander and an outlet connection of the piping removing the purging air from the adsorber is an outlet of the discharge air from the LAES system.

In the first embodiments or any other of the disclosed embodiments, the system can include piping connections, wherein an inlet connection of the piping delivering the purging air to the adsorber bed for its regeneration is an outlet of the low pressure expander and an outlet connection of the piping removing the purging air from the adsorber is an outlet of the discharge air from the LAES system.

In the first embodiments or any other of the disclosed embodiments, the system can include piping connections, wherein an inlet connection of the piping delivering the purging air to the adsorber bed for its regeneration is an outlet of the discharge air reheater and an outlet connection of the piping removing the purging air from the adsorber is an inlet of the low pressure air expander.

In one or more second embodiments, a liquid air energy storage (LAES) system comprises a compressor unit, a hot thermal storage unit, an adsorber unit, a cryogenic unit, a liquid air expander unit, and a liquid air pump unit. The compressor unit can have low and high pressure compressors connected in series. The hot thermal storage unit can be connected to the compressor unit to store heat of compression of a charging air stream therefrom. The adsorber unit can have an adsorbent selected to capture CO2 and moisture when charging air flows therethrough and to release CO2 and moisture when desorption air flows therethrough. The cryogenic unit can have one or more cold thermal storage units that receive a charging air flow and a discharging air flow and provide liquefaction of the charging air stream and evaporation of the discharging air stream. The liquid air expander unit can be adapted to cool the charging air flow by adiabatic expansion and connected to convey the charging air stream as a mixed phase flow to a flash liquid air separator unit, the mixed phase flow liquid component being separated in the liquid air expander and conveyed to a liquid air storage unit and the mixed phase flow gaseous component being vented. The liquid air pump unit can be selected to extract a discharging air flow from the liquid air storage unit during a discharging operation and convey the discharging air flow to an air expander unit with a power output, the air expander providing the desorption flow to the adsorber unit. The high and low pressure compressors can be adiabatic compressors selected to provide a pressure of the charging air at the outlet of the high pressure adiabatic compressor in the range from 39 to 75 barA and a compression ratio in the low pressure compressor in the range from 11 to 35. The hot thermal storage unit including a charging air intercooler selected to provide a temperature of the low-pressure charging air at its outlet in the range from 40 to 60° C. and a charging air aftercooler connected downstream of the high-pressure compressor. The expander unit can include two high and low pressure adiabatic expanders connected in series and selected to provide an expansion ratio in the high pressure expander between 9 and 43 and a pressure of the discharged air at the outlet of the low pressure expander at 0.05-0.1 bar at most above atmospheric pressure. The hot thermal storage unit can include a discharging stream preheater selected to provide a temperature of the high-pressure discharging air stream at its outlet of up to 550° C. and discharging air stream reheater upstream of the low-pressure expander. The liquid air pump unit can be selected to provide a ratio of the pressures of the charging air stream at the inlet of the cryogenic unit 500 during LAES charge phase to that of the discharged air stream at the inlet of the cryogenic unit 500 during LAES discharge phase in the range from 1.15 to 3.35. The cryogenic unit can be selected to provide a difference between a temperature of the charging air stream at the inlet of the cryogenic unit and a temperature of the discharging air stream at the outlet of the cryogenic unit between 1 to 13° C.

In the second embodiments or any other of the disclosed embodiments, the cryogenic unit can be configured such that that ratio of pressure of the charging and discharging air streams at the charging inlet and discharging outlet thereof is diminished with a diminishing selected difference in temperature of the charging and discharging air streams at the charging inlet and discharging outlet.

In the second embodiments or any other of the disclosed embodiments, the low pressure compressor can include an adiabatic industrial turbocompressor or gas turbine and provides a temperature of charging air at its outlet between 350 and 550° C.

In the second embodiments or any other of the disclosed embodiments, a low pressure compressor can include at least two adiabatic compressors connected in-series.

In the second embodiments or any other of the disclosed embodiments, the low pressure compressor can include an adiabatic industrial turbocompressor or gas turbine and provides a compression ratio selected in the range 2 and 8.

In the second embodiments or any other of the disclosed embodiments, the high pressure compressor can include two adiabatic compressors connected in-series.

In the second embodiments or any other of the disclosed embodiments, the charging air intercooler can be with the first heat storage and the first heat storage can use a solid storing material for a direct exchange of thermal energy with a low pressure charging air and a storage of captured high-temperature compression heat energy between the charging and discharging the LAES system.

In the second embodiments or any other of the disclosed embodiments, the hot thermal storage can have two stages with the charging air intercooler connected between them.

In the second embodiments or any other of the disclosed embodiments, the charging air intercooler can include a balance water- or air-cooled heat exchanger with a condensate drainage adapted for further reducing a temperature of the charging air stream to a level of 30° C. at at least the inlet of the adsorber unit 400 and high pressure compressor.

In the second embodiments or any other of the disclosed embodiments, the adsorber unit is includes a pressurized vessel with at least one bed of industrial adsorbent adapted for the temperature of charging air at the outlet of the low pressure compressor.

In the second embodiments or any other of the disclosed embodiments, the adsorber can be connected between the balance heat exchanger and the high pressure compressor, an industrial sorbent in the adsorber providing a temperature swing adsorption of contaminants selected for a charging air temperature at the outlet of the low pressure compressor in the range between 350 and 400° C.

In the second embodiments or any other of the disclosed embodiments, the adsorber is connected between the balance heat exchanger and the cryogenic unit, an industrial sorbent in the adsorber providing a temperature swing adsorption of contaminants selected for a charging air temperature at the outlet of the low pressure compressor in the range between 500 and 550° C.

In the second embodiments or any other of the disclosed embodiments, for the charging air temperature at the outlet of the low pressure compressor in the range between 400 and 500° C., a placement of the adsorber and a type of an industrial sorbent used can be selected with regard to a relationship between the pressure of charging air at the outlet of low pressure compressor and the pressure of discharged air at the inlet of low pressure expander according to table 30.

In the second embodiments or any other of the disclosed embodiments, the adsorber can be connected between the between the balance heat exchanger and the high pressure compressor, an industrial sorbent in the adsorber providing a temperature swing adsorption of contaminants selected for a charging air temperature at the outlet of the low pressure compressor in the range between 400 and 500° C. and a ratio of the pressure of charging air at the outlet of low pressure compressor to the pressure of discharged air at the inlet of low pressure expander is in the range of 4 to 8.

In the second embodiments or any other of the disclosed embodiments, the adsorber can be connected between the balance heat exchanger and the cryogenic unit, an industrial sorbent in the adsorber providing a temperature assisted pressure swing adsorption of contaminants selected for a charging air temperature at the outlet of the low pressure compressor in the range between 400 and 500° C. and a ratio of the pressure of charging air at the outlet of low pressure compressor to the pressure of discharged air at the inlet of low pressure expander is in the range of 8 to 12.

In the second embodiments or any other of the disclosed embodiments, the charging air aftercooler can be a part of the hot thermal storage, employing solid storing media for a direct exchange, or liquid media for indirect exchange, of thermal energy with the high pressure charging air stream and storage of captured compression heat energy of the charging air stream and recovery to the discharging air stream.

In the second embodiments or any other of the disclosed embodiments, the cryogenic unit can include a cold heat exchanger and at least one of the cold thermal storage units, the cold heat exchanger providing correspondingly 2-3% of the total cold capacity for liquefaction of the charging air stream.

In the second embodiments or any other of the disclosed embodiments, cold thermal storage units can be connected in-series and the cold heat exchanger is connected in parallel with one of the cold thermal storage units.

In the second embodiments or any other of the disclosed embodiments, the cryogenic unit can have a controlled divider at the inlet thereof adapted for separating a mass flow of charging air between the first cold storage and the cold heat exchanger in the proportion range (94-96)% to (6-4)%.

In the second embodiments or any other of the disclosed embodiments, the cryogenic unit can have an uncontrolled mixer connected upstream of one of the cold thermal storage units arranged to mix the charging air streams leaving one of the cold thermal storage units and the cold heat exchanger.

In the second embodiments or any other of the disclosed embodiments, the first cold storage can cool the passing charging air down to −120-−140° C., providing 57-59% of a total cold capacity of the cryogenic unit, whereas the second cold storage is adapted to liquefy and subcool the full charging air flow down to −186-−187° C., providing 39-40% of total cold capacity of the cryogenic unit.

In the second embodiments or any other of the disclosed embodiments, the cryogenic unit 500 can be designed to provide a rated difference in temperature of the fully liquefied charging air stream at the outlet of the second cold storage 522 during LAES system charge and of the liquid discharged air stream at the inlet of the second cold storage 522 during LAES system discharge in the range between 3.0 and 5.0° C.

In one or more third embodiments, a liquid air energy storage (LAES) system comprises in combination a compressor unit, a hot thermal energy storage unit, an adsorber unit, a cryogenic unit, a liquid air expander unit, a liquid air separator unit, a liquid air storage unit, a liquid air pump unit, an expander unit, and piping. The compressor unit can consume off-peak power and providing compression of a charging air up to a pressure above a critical pressure. The hot thermal energy storage unit can be adapted to capture, store and recover compression heat for superheating and reheating a discharged air. The adsorber unit can provide physical adsorption of the CO₂ and atmospheric moisture from a pressurized charging air and regeneration of the sorbent bed. The cryogenic unit can be adapted to deep cooling and liquefaction of the pressurized charging air and re-gasification of pumped discharged air. The liquid air expander unit can provide depressurization and cooling of the liquid charging air. The liquid air separator unit can provide further depressurization, cooling, and separation of the charging air into liquid air and vapor (vent) streams. The liquid air pump unit can pump a discharged liquid air at a selected pressure below one of charging air. The expander unit can provide expansion of the pressurized discharged air and producing on-peak power. The piping can provide the interconnections of equipment to permit regeneration of the adsorber bed during LAES discharge. The compressor unit can include a combination of at most two placed in-series adiabatic compression stages providing a pressure of the charging air at the outlet of compressor unit in the range from 39 to 80 barA with a compression ratio in the one-stage compressor unit set up at a level of at least 39 or a compression ratio in the first stage of compressor unit selected in the range from 11 to 39. The expander unit can include a combination of at most two placed in-series adiabatic expansion stages providing an expansion ratio in the first stage of expander unit between 9 and 43 and expansion of air in the expander unit from a selected discharged air pressure down to an exhaust pressure exceeding an atmospheric pressure by 0.05-0.2 bar at most. The hot thermal energy storage unit can include a combination of at most two hot thermal energy storages in which the first storage is adapted to capture and store a compression heat generated correspondingly by one-stage or the first stage compressors and to recover a stored compression heat by one-stage or the first stage expanders correspondingly, whereas the second storage is adapted to capture and store a compression heat generated by the second stage compressor and to recover a stored compression heat by the second stage expander. The liquid air pump unit can pump a discharged air from a liquid air storage unit at a selected pressure providing a relationship between the pressures of the charging air at the inlet of the cryogenic unit during LAES charge phase and of discharged air stream at the inlet of the cryogenic unit during LAES discharge phase in the range from 1.15 to 3.35. The cryogenic unit can provide a difference in temperature of the gaseous charging air stream at the inlet of the unit during LAES charge phase and of the re-gasified discharged air stream at the outlet of the unit during LAES discharge phase, selected in the range from 1 to 13° C. The cryogenic unit can provide a lesser value of the relationship between the pressure of the charging and discharged air streams at a lesser value of the difference in temperature of the gaseous charging and re-gasified discharged air streams at a rated air liquefaction ratio of 95-96% and a rated difference in 3-5° C. between the temperatures of liquid charging air at the outlet of the cryogenic unit and liquid discharged air at the inlet of the cryogenic unit.

In the third embodiments or any other of the disclosed embodiments, the compressor unit can be a one-stage adiabatic turbo-machinery, including the one-stage adiabatic compressor with charging air aftercooler and providing the temperatures of charging air at the outlet of the equipment in the ranges 350-580° C. and 40-60° C. respectively.

In the third embodiments or any other of the disclosed embodiments, the compressor unit can be a two-stage semi-adiabatic turbo-machinery, including placed in-series the first stage with a low pressure adiabatic compressor and charging air intercooler, and the second stage with a high pressure adiabatic compressor and charging air aftercooler.

In the third embodiments or any other of the disclosed embodiments, the compressor unit can provide the temperatures of charging air at the outlet of the equipment in the following ranges: 350-580° C. and 40-60° C. respectively for the first stage of compressor unit and 280-120° C. and 40-60° C. respectively for the second stage of compressor unit.

In the third embodiments or any other of the disclosed embodiments, the compressor unit can be a two-stage semi-adiabatic turbo-machinery, providing a charging air pressure at the outlet of high pressure compressor below 55 barA and a charging air temperature at the outlet of low pressure compressor above 500° C., whereas the expander unit is a one-stage adiabatic expander.

In the third embodiments or any other of the disclosed embodiments, the expander unit can be a one-stage adiabatic turbo-machinery, including the placed in-series discharged air superheater and an adiabatic expander.

In the third embodiments or any other of the disclosed embodiments, the expander unit can be a two-stage semi-adiabatic turbo-machinery, including placed in-series the first stage with discharged air superheater and high pressure adiabatic expander, and the second stage with discharged air reheater and low pressure adiabatic expander, and providing an expansion ratio in the high pressure expander selected in the following ranges: between 9.5 and 10.5 for the case of charging air temperature at outlet of the first stage compressor in the range from 300 to 400° C.; between 16.5 and 19 for the case of charging air temperature at outlet of the first stage compressor in the range from 400 to 500° C.; and between 27.5 and 42.5 for the case of charging air temperature at outlet of the first stage compressor in the range from 500 to 575° C.

In the third embodiments or any other of the disclosed embodiments, the compressor and/or expander units can be the set of the multiple compressor and/or expander unit(s) placed in parallel to achieve a predefined ultimate total output of the large-scale LAES systems exceeding 100-300 MW of discharged power.

In the third embodiments or any other of the disclosed embodiments, the charging air intercooler and aftercooler can be used for supplying the hot thermal energy storages with compression heat during LAES charge, whereas the discharged air superheater and reheater are used for extraction of stored compression heat from the hot thermal storages and its recovery during LAES discharge.

In the third embodiments or any other of the disclosed embodiments, the heat storing media for the hot thermal energy storages can be selected from the group including solid, liquid, phase-change materials and combination thereof and configured in such way to provide a direct or indirect exchange of thermal energy stored by this media with the charging and discharge air streams using the charging air intercooler and/or aftercooler and the discharged air reheater and/or superheater.

In the third embodiments or any other of the disclosed embodiments, the charging air intercooler and aftercooler can be integrated with the rear-mounted balance water-or-air-cooled heat exchangers, providing a further reduction in temperature of charging air at their outlet down to 30° C. at least and drainage of condensate from cooled air.

In the third embodiments or any other of the disclosed embodiments, the adsorber unit can be one pressurized vessel with at least one bed of the known industrial adsorbent, type of which and adsorber placement in the LAES system are selected with regard to a configuration of compressor unit and a pressure of charging air at its outlet.

In the third embodiments or any other of the disclosed embodiments, a placement of the adsorber unit with an industrial sorbent providing a temperature swing adsorption of contaminants can be selected between the first balance heat exchanger and the high pressure compressor for the two-stage semi-adiabatic compressor unit.

In the third embodiments or any other of the disclosed embodiments, a placement of the adsorber unit with an industrial sorbent providing a pressure-assisted temperature swing adsorption of contaminants can be selected between the first balance heat exchanger and the cryogenic unit.

In the third embodiments or any other of the disclosed embodiments, the cryogenic unit can be installed downstream of the first or second balanced heat exchanger and designed as a combination of cold thermal energy storage, partitioned into placed in-series first and second storages and providing 57-59% and 39-40% respectively of a total cold capacity of the cryogenic unit, and a vapor cold exchanger, arranged in parallel with the first storage and providing up to 3% of total cold capacity of cryogenic unit.

In the third embodiments or any other of the disclosed embodiments, the cryogenic unit can be equipped with a controlled divider installed at the inlet of unit and intended for separating a mass flow of charging air between the first cold storage and the vapor cold exchanger in the proportion (94-96)% to (6-4)%, and with an uncontrolled mixer installed upstream of the second cold storage and intended for mixing the charging air streams escaping the first cold storage and the vapor cold exchanger.

In the third embodiments or any other of the disclosed embodiments, the first cold storage and vapor cold exchanger can be adapted to deeply cool the passing charging air down to −120-−140° C., whereas the second cold storage is adapted to liquefy and further cool the full charging air flow down to −186-−187° C.

In the third embodiments or any other of the disclosed embodiments, a cold storing media for the cold thermal energy storage can be selected from the group including solid, liquid, phase-change materials and/or combination thereof and providing a direct or indirect exchange of thermal energy stored by this media with the charging and discharge air streams in the range of their inlet and outlet temperatures.

In the third embodiments or any other of the disclosed embodiments, either of the two or both cold storages can be designed as the partitioned into the separate, placed in-series modules filled with the different solid, liquid or phase-change cold storage media, possessing the different thermodynamic properties and providing a direct or in-direct thermal energy transfer with the charging and discharged air streams in the range of their inlet and outlet temperatures.

In the third embodiments or any other of the disclosed embodiments, the liquid air expander unit can provide a share of vapor phase in the charging air stream at its outlet in the range between 0 and 0.5%.

In the third embodiments or any other of the disclosed embodiments, the liquid air separator unit can be designed to provide the rated air liquefaction ratio by setting the temperature and pressure of the vapor and liquid phases of a charging air stream at its outlet in the range from 1.29 and 1.35 barA and between −191.7 and −192.1° C. correspondingly.

In the third embodiments or any other of the disclosed embodiments, the piping can be used for adsorber bed thermal regeneration during LAES discharge and including the piping used for delivery the CO₂ and moisture-free discharged air as heating gaseous stream from exhaust of the expander train to the bed of adsorber unit and the piping used for removal of the stream together with CO₂ and atmospheric moisture from the adsorbent bed into atmosphere.

In one or more fourth embodiments, a liquid air energy storage (LAES) system comprising in combination a compressor unit, a hot thermal energy storage unit, an adsorber, a cryogenic unit, a liquid air expander unit, a liquid air separator unit, a liquid air storage unit, a liquid air pump unit, and an expander unit. The compressor unit can compress charging air up to a pressure above a critical pressure. The hot thermal energy storage unit can be connected to receive compressed charging air from the compressor unit and store compression heat. The adsorber can be connected to receive the charging air and adsorb CO2 and atmospheric moisture from a pressurized charging air and connected to a sorbent bed to regenerate it. The cryogenic unit can be connected to deep cool and liquefy the pressurized charging air at least in part by re-gasifying discharged air. The liquid air expander unit can receive air from the cyrogenic unit and provide depressurization and cooling of the liquid charging air. The liquid air separator unit can provide further depressurization, cooling, and separation of the charging air into liquid air and vapor (vent) streams. The liquid air storage unit can be connected to the air separate to receive a liquid air therefrom. The liquid air pump unit can be connected to pump a discharged liquid air at a selected pressure below a pressure of the charging air. The expander unit can provide expansion of the pressurized discharged air and having a generation to produce on-peak power;. The adsorber can be connected to receive discharge air from downstream of the liquid air pump unit to permit regeneration of the adsorber bed. The compressor unit can inlcude a combination of at most two placed in-series adiabatic compression stages providing a pressure of the charging air at the outlet of compressor unit in the range from 39 to 80 barA with a compression ratio in the one-stage compressor unit set up at a level of at least 39 or a compression ratio in the first stage of compressor unit selected in the range from 11 to 39. The expander unit can include a combination of at most two placed in-series adiabatic expansion stages providing an expansion ratio in the first stage of expander unit between 9 and 43 and expansion of air in the expander unit from a selected discharged air pressure down to an exhaust pressure exceeding an atmospheric pressure by 0.05-0.2 bar at most. The hot thermal energy storage unit can include a combination of at most two hot thermal energy storages in which the first storage is connected to capture and store a compression heat generated correspondingly by one-stage or the first stage compressors and to recover a stored compression heat by one-stage or the first stage expanders correspondingly, whereas the second storage is connected to capture and store a compression heat generated by the second stage compressor and to recover a stored compression heat by the second stage expander. The liquid air pump unit can be connected to pump a discharged air from a liquid air storage unit at a selected pressure providing a relationship between the pressures of the charging air at the inlet of the cryogenic unit during LAES charge phase and of discharged air stream at the inlet of the cryogenic unit during LAES discharge phase in the range from 1.15 to 3.35. The cryogenic unit can be configured and controlled to provide a difference in temperature of the gaseous charging air stream at the inlet of the unit during LAES charge phase and of the re-gasified discharged air stream at the outlet of the unit during LAES discharge phase, selected in the range from 1 to 13° C. The cryogenic unit can be configured and controlled to provide a lesser value of the relationship between the pressure of the charging and discharged air streams at a lesser value of the difference in temperature of the gaseous charging and re-gasified discharged air streams at a rated air liquefaction ratio of 95-96% and a rated difference in 3-5° C. between the temperatures of liquid charging air at the outlet of the cryogenic unit and liquid discharged air at the inlet of the cryogenic unit.

In the fourth embodiments or any other of the disclosed embodiments, the compressor unit can be a one-stage adiabatic turbo-machinery, including the one-stage adiabatic compressor with charging air aftercooler and providing the temperatures of charging air at the outlet of the equipment in the ranges 350-580° C. and 40-60° C. respectively.

In the fourth embodiments or any other of the disclosed embodiments, the compressor unit can be a two-stage semi-adiabatic turbo-machinery, including placed in-series the first stage with a low pressure adiabatic compressor and charging air intercooler, and the second stage with a high pressure adiabatic compressor and charging air aftercooler.

In the fourth embodiments or any other of the disclosed embodiments, the compressor unit can provide the temperatures of charging air at the outlet of the equipment in the following ranges: 350-580° C. and 40-60° C. respectively for the first stage of compressor unit and 280-120° C. and 40-60° C. respectively for the second stage of compressor unit.

In the fourth embodiments or any other of the disclosed embodiments, the compressor unit can be a two-stage semi-adiabatic turbo-machinery, providing a charging air pressure at the outlet of high pressure compressor below 55 barA and a charging air temperature at the outlet of low pressure compressor above 500° C., whereas the expander unit is a one-stage adiabatic expander.

In the fourth embodiments or any other of the disclosed embodiments, the expander unit can be a one-stage adiabatic turbo-machinery, including the placed in-series discharged air superheater and an adiabatic expander.

In the fourth embodiments or any other of the disclosed embodiments, the expander unit can be a two-stage semi-adiabatic turbo-machinery, including placed in-series the first stage with discharged air superheater and high pressure adiabatic expander, and the second stage with discharged air reheater and low pressure adiabatic expander, and providing an expansion ratio in the high pressure expander selected in the following ranges: between 9.5 and 10.5 for the case of charging air temperature at outlet of the first stage compressor in the range from 300 to 400° C.; between 16.5 and 19 for the case of charging air temperature at outlet of the first stage compressor in the range from 400 to 500° C.; and between 27.5 and 42.5 for the case of charging air temperature at outlet of the first stage compressor in the range from 500 to 575° C.

In the fourth embodiments or any other of the disclosed embodiments, the compressor and/or expander units can be the set of the multiple compressor and/or expander unit(s) placed in parallel to achieve a predefined ultimate total output of the large-scale LAES systems exceeding 100-300 MW of discharged power.

In the fourth embodiments or any other of the disclosed embodiments, the charging air intercooler and aftercooler can be used for supplying the hot thermal energy storages with compression heat during LAES charge, whereas the discharged air superheater and reheater are used for extraction of stored compression heat from the hot thermal storages and its recovery during LAES discharge.

In the fourth embodiments or any other of the disclosed embodiments, the heat storing media for the hot thermal energy storages can be selected from the group including solid, liquid, phase-change materials and combination thereof and configured in such way to provide a direct or indirect exchange of thermal energy stored by this media with the charging and discharge air streams using the charging air intercooler and/or aftercooler and the discharged air reheater and/or superheater.

In the fourth embodiments or any other of the disclosed embodiments, the charging air intercooler and aftercooler can be integrated with the rear-mounted balance water-or-air-cooled heat exchangers, providing a further reduction in temperature of charging air at their outlet down to 30° C. at least and drainage of condensate from cooled air.

In the fourth embodiments or any other of the disclosed embodiments, the adsorber unit can be one pressurized vessel with at least one bed of the known industrial adsorbent, type of which and adsorber placement in the LAES system are selected with regard to a configuration of compressor unit and a pressure of charging air at its outlet.

In the fourth embodiments or any other of the disclosed embodiments, a placement of the adsorber unit with an industrial sorbent providing a temperature swing adsorption of contaminants can be selected between the first balance heat exchanger and the high pressure compressor for the two-stage semi-adiabatic compressor unit.

In the fourth embodiments or any other of the disclosed embodiments, a placement of the adsorber unit with an industrial sorbent providing a pressure-assisted temperature swing adsorption of contaminants can be selected between the first balance heat exchanger and the cryogenic unit.

In the fourth embodiments or any other of the disclosed embodiments, the cryogenic unit can be installed downstream of the first or second balanced heat exchanger and designed as a combination of cold thermal energy storage, partitioned into placed in-series first and second storages and providing 57-59% and 39-40% respectively of a total cold capacity of the cryogenic unit, and a vapor cold exchanger, arranged in parallel with the first storage and providing up to 3% of total cold capacity of cryogenic unit.

In the fourth embodiments or any other of the disclosed embodiments, the cryogenic unit can be equipped with a controlled divider installed at the inlet of unit and intended for separating a mass flow of charging air between the first cold storage and the vapor cold exchanger in the proportion (94-96)% to (6-4)%, and with an uncontrolled mixer installed upstream of the second cold storage and intended for mixing the charging air streams escaping the first cold storage and the vapor cold exchanger.

In the fourth embodiments or any other of the disclosed embodiments, the first cold storage and vapor cold exchanger can be adapted to deeply cool the passing charging air down to −120-−140° C., whereas the second cold storage is adapted to liquefy and further cool the full charging air flow down to −186-−187° C.

In the fourth embodiments or any other of the disclosed embodiments, a cold storing media for the cold thermal energy storage can be selected from the group including solid, liquid, phase-change materials and/or combination thereof and providing a direct or indirect exchange of thermal energy stored by this media with the charging and discharge air streams in the range of their inlet and outlet temperatures.

In the fourth embodiments or any other of the disclosed embodiments, either of the two or both cold storages can be designed as the partitioned into the separate, placed in-series modules filled with the different solid, liquid or phase-change cold storage media, possessing the different thermodynamic properties and providing a direct or in-direct thermal energy transfer with the charging and discharged air streams in the range of their inlet and outlet temperatures.

In the fourth embodiments or any other of the disclosed embodiments, the liquid air expander unit can provide a share of vapor phase in the charging air stream at its outlet in the range between 0 and 0.5%.

In the fourth embodiments or any other of the disclosed embodiments, the liquid air separator unit can be designed to provide the rated air liquefaction ratio by setting the temperature and pressure of the vapor and liquid phases of a charging air stream at its outlet in the diapason from 1.29 and 1.35 barA and between −191.7 and −192.1° C. correspondingly.

In the fourth embodiments or any other of the disclosed embodiments, the piping can be used for adsorber bed thermal regeneration during LAES discharge and including the piping used for delivery the CO2 and moisture-free discharged air as heating gaseous stream from exhaust of the expander train to the bed of adsorber unit and the piping used for removal of the stream together with CO2 and atmospheric moisture from the adsorbent bed into atmosphere.

It will be appreciated that the modules, processes, systems, and sections described above can be implemented in hardware, hardware programmed by software, software instruction stored on a non-transitory computer readable medium or a combination of the above. For example, a method for liquid air energy storage systems can be implemented, for example, using a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of energy processing and storage and/or computer programming arts.

Moreover, embodiments of the disclosed method, system, and computer program product can be implemented in software executed on a programmed general purpose computer, a special purpose computer, a microprocessor, or the like.

It is, thus, apparent that there is provided, in accordance with the present disclosure, liquid air energy storage systems, methods, and devices. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

1. A liquid air energy storage (LAES) system, comprising in combination:
a compressor unit providing compression of a charging air up to a pressure above a critical value;
a hot thermal energy storage unit adapted to capture and store compression heat;
an adsorber unit providing physical adsorption of the CO2 and atmospheric moisture from a pressurized charging air and regeneration of sorbent bed by purging discharge air;
a cryogenic unit adapted to liquefaction of the pressurized charging air by capturing a cold thermal energy from a cold storing media in an integrated cold thermal energy storage and from a cold vaporized air stream in an integrated vapor cold exchanger;
a liquid air expander unit providing depressurization of the liquified charging air;
a liquid air separator unit providing further depressurization and separation of the charging air into liquid air and vapor streams;
a liquid air storage unit providing storage of a liquid air between the LAES charge and discharge periods;
a liquid air pump unit providing delivery of a discharge air into the cryogenic unit at a selected discharge pressure;
the cryogenic unit adapted to cause evaporation of the pressurized discharge air by transfer of its cold thermal energy into a cold storing media in the integrated cold thermal energy storage;
the hot thermal energy storage unit adapted to recovery of stored compression heat for preheating and reheating the pressurized discharge air;
an expander unit providing expansion of the pressurized discharged air up to a selected exhaust pressure at its outlet;
piping providing delivery of purging discharge air to the bed of the adsorber unit and removal of this stream together with CO₂ and atmospheric moisture from the adsorbent bed;
the compressor unit including a combination of at most two placed in-series adiabatic compressors providing a pressure of the charging air at the outlet of compressor unit in the range from 39 to 80 barA with a compression ratio of the one-stage compressor set up at a level of at least 39 or a compression ratio of the first stage compressor selected in the range from 11 to 39;
the expander unit including a combination of at most two placed in-series adiabatic expanders providing an expansion ratio of the first stage expander between 9 and 43 and expansion of air in the two-stage or a single one-stage expanders from a selected discharge air pressure down to a selected exhaust pressure exceeding an atmospheric pressure by 0.05-0.1 bar at most;
the hot thermal energy storage unit including a combination of at most two hot thermal energy storages in which a single or the first storage is adapted to capture and store a compression heat generated correspondingly by a single one-stage or the first stage compressors and to recover a stored compression heat by a single one-stage or the first stage expanders correspondingly, whereas the second storage is adapted to capture and store a compression heat generated by the second stage compressor and to recover a stored compression heat by the second stage expander;
the liquid air pump unit pumping a discharge air from a liquid air storage unit at a selected pressure providing a relationship between the pressures of the charging air at the inlet of the cryogenic unit during LAES charge phase and of discharge air stream at the inlet of the cryogenic unit during LAES discharge phase in the range from 1.15 to 3.35;
the cryogenic unit providing a difference in temperature of the charging air stream at the inlet of the unit during LAES charge phase and of the discharge air stream at the outlet of the unit during LAES discharge phase selected in the range from 1 to 13° C.; and
the cryogenic unit providing a lesser value of the relationship between the pressure of the charging and discharge air streams at a lesser value of the difference in temperature of the charging and discharge air streams at a rated air liquefaction ratio of 95-96% and a rated difference in 3-5° C. between the temperatures of charging air at the outlet of the cryogenic unit and of discharge air at the inlet of the cryogenic unit.

2. A LAES system of claim 1, wherein the compressor unit is a one-stage adiabatic turbo-machinery, including the placed in-series one-stage adiabatic compressor, single aftercooler and single balance heat exchanger, and providing the temperatures of charging air at the outlet of the equipment in the following ranges: 350-580° C., 40-60° C., and at most 30° C.

3. A LAES system of claim 1, wherein the compressor unit is a two-stage semi-adiabatic turbo-machinery, including the placed in-series low pressure adiabatic compressor, intercooler, first balance heat exchanger, high pressure adiabatic compressor, aftercooler and second balance heat exchanger, and providing the temperatures of charging air at the outlet of the equipment in the following ranges: 350-580° C., 40-60° C., at most 30° C., 260-40° C., 40-120° C. and at most 30° C., correspondingly.

4. A LAES system of claim 1, wherein the compressor unit is either a one-stage adiabatic compressor or a two-stage semi-adiabatic compressor each designed as a set of the multiple adiabatic compressors placed in-series to achieve a predefined ultimate compression ratio.

5. A LAES system of claim 1, wherein the compressor unit is a two-stage semi-adiabatic turbo-machinery, providing a charging air pressure at the outlet of high pressure compressor below 55 barA and a charging air temperature at the outlet of low pressure compressor above 500° C., whereas the expander unit is a one-stage adiabatic expander.

6. A LAES system of claim 1, wherein the expander unit is a one-stage adiabatic turbo-machinery, including the placed in-series discharge air preheater and an adiabatic expander.

7. A LAES system of claim 1, wherein the expander unit is a two-stage semi-adiabatic turbo-machinery, including the placed in-series discharge air preheater, high pressure adiabatic expander, discharge air reheater and low pressure adiabatic expander, and providing an expansion ratio of the high pressure expander selected in the following ranges: between 9.5 and 10.5 for the case of charging air temperature at outlet of the first stage compressor in the range from 300 to 400° C.; between 16.5 and 19 for the case of charging air temperature at outlet of the first stage compressor in the range from 400 to 500° C.; and between 27.5 and 42.5 for the case of charging air temperature at outlet of the first stage compressor in the range from 500 to 575° C.

8. (canceled)

9. A LAES system of claim 1, the compressor and/or expander units are/is the set of the multiple compressor and/or expander unit(s) placed in parallel to achieve a predefined ultimate total output of the large-scale LAES systems exceeding 100 MW of discharged power.

10. A LAES system of claim 1, wherein the single hot thermal energy storage is integrated with the discharge air preheater and the charging air aftercooler, the first hot thermal energy storage is integrated with the discharge air preheater and the charging air intercooler, and the second hot thermal energy storage is integrated with the discharge air reheater and the charging air aftercooler, whereas a heat storing media for any the hot thermal energy storage is selected from the group including solid, liquid, phase-change materials and combination thereof, providing a direct or indirect exchange of thermal energy stored by this media with the charging and discharge air streams.

11-55. (canceled)

56. A liquid air energy storage (LAES) system, comprising in combination:
a compressor unit consuming off-peak power and providing compression of a charging air up to a pressure above a critical pressure;
a hot thermal energy storage unit adapted to capture, store and recover compression heat for superheating and reheating a discharged air;
an adsorber unit providing physical adsorption of the CO2 and atmospheric moisture from a pressurized charging air and regeneration of the sorbent bed;
a cryogenic unit adapted to deep cooling and liquefaction of the pressurized charging air and re-gasification of pumped discharged air;
a liquid air expander unit providing depressurization and cooling of the liquid charging air;
a liquid air separator unit providing further depressurization, cooling, and separation of the charging air into liquid air and vapor (vent) streams;
a liquid air storage unit;
a liquid air pump unit to pump a discharged liquid air at a selected pressure below one of charging air;
an expander unit providing expansion of the pressurized discharged air and producing on-peak power; and
the piping providing the interconnections of equipment to permit regeneration of the adsorber bed during LAES discharge;
the compressor unit including a combination of at most two placed in-series adiabatic compression stages providing a pressure of the charging air at the outlet of compressor unit in the range from 39 to 80 barA with a compression ratio in the one-stage compressor unit set up at a level of at least 39 or a compression ratio in the first stage of compressor unit selected in the range from 11 to 39;
the expander unit including a combination of at most two placed in-series adiabatic expansion stages providing an expansion ratio in the first stage of expander unit between 9 and 43 and expansion of air in the expander unit from a selected discharged air pressure down to an exhaust pressure exceeding an atmospheric pressure by 0.05-0.2 bar at most;
the hot thermal energy storage unit including a combination of at most two hot thermal energy storages in which the first storage is adapted to capture and store a compression heat generated correspondingly by one-stage or the first stage compressors and to recover a stored compression heat by one-stage or the first stage expanders correspondingly, whereas the second storage is adapted to capture and store a compression heat generated by the second stage compressor and to recover a stored compression heat by the second stage expander;
the liquid air pump unit pumping a discharged air from a liquid air storage unit at a selected pressure providing a relationship between the pressures of the charging air at the inlet of the cryogenic unit during LAES charge phase and of discharged air stream at the inlet of the cryogenic unit during LAES discharge phase in the range from 1.15 to 3.35;
the cryogenic unit providing a difference in temperature of the gaseous charging air stream at the inlet of the unit during LAES charge phase and of the re-gasified discharged air stream at the outlet of the unit during LAES discharge phase, selected in the range from 1 to 13° C.; and
the cryogenic unit providing a lesser value of the relationship between the pressure of the charging and discharged air streams at a lesser value of the difference in temperature of the gaseous charging and re-gasified discharged air streams at a rated air liquefaction ratio of 95-96% and a rated difference in 3-5° C. between the temperatures of liquid charging air at the outlet of the cryogenic unit and liquid discharged air at the inlet of the cryogenic unit.

57. A LAES system of claim 56, wherein the compressor unit is a one-stage adiabatic turbo-machinery, including the one-stage adiabatic compressor with charging air aftercooler and providing the temperatures of charging air at the outlet of the equipment in the ranges 350-580° C. and 40-60° C. respectively.

58. A LAES system of claim 56, wherein the compressor unit is a two-stage semi-adiabatic turbo-machinery, including placed in-series the first stage with a low pressure adiabatic compressor and charging air intercooler, and the second stage with a high pressure adiabatic compressor and charging air aftercooler.

59. A LAES system of claim 58, wherein the compressor unit provides the temperatures of charging air at the outlet of the equipment in the following ranges: 350-580° C. and 40-60° C. respectively for the first stage of compressor unit and 280-120° C. and 40-60° C. respectively for the second stage of compressor unit.

60. A LAES system of claim 56, wherein the compressor unit is a two-stage semi-adiabatic turbo-machinery, providing a charging air pressure at the outlet of high pressure compressor below 55 barA and a charging air temperature at the outlet of low pressure compressor above 500° C., whereas the expander unit is a one-stage adiabatic expander.

61. A LAES system of claim 56, wherein the expander unit is a one-stage adiabatic turbo-machinery, including the placed in-series discharged air superheater and an adiabatic expander.

62-77. (canceled)

78. A liquid air energy storage (LAES) system, comprising in combination:
a compressor unit that compresses charging air up to a pressure above a critical pressure;
a hot thermal energy storage unit connected to receive compressed charging air from the compressor unit and store compression heat;
an adsorber connected to receive the charging air and adsorb CO2 and atmospheric moisture from a pressurized charging air and connected to a sorbent bed to regenerate it;
a cryogenic unit connected to deep cool and liquefy the pressurized charging air at least in part by re-gasifying discharged air;
a liquid air expander unit receiving air from the cyrogenic unit and providing depressurization and cooling of the liquid charging air;
a liquid air separator unit providing further depressurization, cooling, and separation of the charging air into liquid air and vapor (vent) streams;
a liquid air storage unit connected to the air separate to receive a liquid air therefrom;
a liquid air pump unit connected to pump a discharged liquid air at a selected pressure below a pressure of the charging air;
an expander unit providing expansion of the pressurized discharged air and having a generation to produce on-peak power;
the adsorber being connected to receive discharge air from downstream of the liquid air pump unit to permit regeneration of the adsorber bed;
the compressor unit including a combination of at most two placed in-series adiabatic compression stages providing a pressure of the charging air at the outlet of compressor unit in the range from 39 to 80 barA with a compression ratio in the one-stage compressor unit set up at a level of at least 39 or a compression ratio in the first stage of compressor unit selected in the range from 11 to 39;
the expander unit including a combination of at most two placed in-series adiabatic expansion stages providing an expansion ratio in the first stage of expander unit between 9 and 43 and expansion of air in the expander unit from a selected discharged air pressure down to an exhaust pressure exceeding an atmospheric pressure by 0.05-0.2 bar at most;
the hot thermal energy storage unit including a combination of at most two hot thermal energy storages in which the first storage is connected to capture and store a compression heat generated correspondingly by one-stage or the first stage compressors and to recover a stored compression heat by one-stage or the first stage expanders correspondingly, whereas the second storage is connected to capture and store a compression heat generated by the second stage compressor and to recover a stored compression heat by the second stage expander;
the liquid air pump unit connected to pump a discharged air from a liquid air storage unit at a selected pressure providing a relationship between the pressures of the charging air at the inlet of the cryogenic unit during LAES charge phase and of discharged air stream at the inlet of the cryogenic unit during LAES discharge phase in the range from 1.15 to 3.35;
the cryogenic unit being configured and controlled to provide a difference in temperature of the gaseous charging air stream at the inlet of the unit during LAES charge phase and of the re-gasified discharged air stream at the outlet of the unit during LAES discharge phase, selected in the range from 1 to 13° C.; and
the cryogenic unit being configured and controlled to provide a lesser value of the relationship between the pressure of the charging and discharged air streams at a lesser value of the difference in temperature of the gaseous charging and re-gasified discharged air streams at a rated air liquefaction ratio of 95-96% and a rated difference in 3-5° C. between the temperatures of liquid charging air at the outlet of the cryogenic unit and liquid discharged air at the inlet of the cryogenic unit.

79-83. (canceled)

84. A LAES system of claim 78, wherein the expander unit is a two-stage semi-adiabatic turbo-machinery, including placed in-series the first stage with discharged air superheater and high pressure adiabatic expander, and the second stage with discharged air reheater and low pressure adiabatic expander, and providing an expansion ratio in the high pressure expander selected in the following ranges: between 9.5 and 10.5 for the case of charging air temperature at outlet of the first stage compressor in the range from 300 to 400° C.; between 16.5 and 19 for the case of charging air temperature at outlet of the first stage compressor in the range from 400 to 500° C.; and between 27.5 and 42.5 for the case of charging air temperature at outlet of the first stage compressor in the range from 500 to 575° C.

85. A LAES system of claim 78, the compressor and/or expander units are/is the set of the multiple compressor and/or expander unit(s) placed in parallel to achieve a predefined ultimate total output of the large-scale LAES systems exceeding 100-300 MW of discharged power.

86. A LAES system of claim 78, wherein the charging air intercooler and aftercooler are used for supplying the hot thermal energy storages with compression heat during LAES charge, whereas the discharged air superheater and reheater are used for extraction of stored compression heat from the hot thermal storages and its recovery during LAES discharge.

87. A LAES system of claim 78, wherein the heat storing media for the hot thermal energy storages are selected from the group including solid, liquid, phase-change materials and combination thereof and configured in such way to provide a direct or indirect exchange of thermal energy stored by this media with the charging and discharge air streams using the charging air intercooler and/or aftercooler and the discharged air reheater and/or superheater.

88-98. (canceled)
